(19) United States
(12) Patent Application Publication
(10) Pub. No.: US 2022/0077449 A1
(43) Pub. Date: Mar. 10, 2022

(54) ELECTROCHEMICAL CELLS, COMPONENTS THEREOF, AND METHODS OF THEIR MANUFACTURE

(71) Applicant: Everon24, Inc., Woburn, MA (US)

(72) Inventor: Rahul Mukherjee, Winchester, MA (US)

(21) Appl. No.: 17/469,392

(22) Filed: Sep. 8, 2021

Related U.S. Application Data
(60) Provisional application No. 63/075,806, filed on Sep. 8, 2020.

(51) Int. Cl. H01M 4/131; H01M 10/054; H01M 4/485; H01M 4/62; H01M 4/36; H01M 4/04

(52) U.S. Cl. CPC H01M 4/131; H01M 10/054; H01M 4/0471; H01M 4/625; H01M 4/366; H01M 4/485

(57) ABSTRACT

Disclosed herein are electrochemical cells and their components. An electrochemical cell may include two electrodes, such as an anode and a cathode, an electrolyte, and, optionally, a separator. An electrochemical cell may include a surface layer. The surface layer may be formed in situ or ex situ and may be grown from or grown into an electrode surface, for example by a pre-treatment, a formation process, and/or during electrochemical cycling. The surface layer may be formed directly on an electrode material, such as an electroactive material or current collector, or on a layer disposed thereon, such as a carbon layer formed by carbonization. A surface layer may be solid or semi-solid, for example a gel or gelatinous. A surface layer may include one or more of: cation(s), anion(s), and functional group(s) that have reacted together. A surface layer may be a charge storage layer/film or a passivation layer.

### PRIORITY APPLICATION

This application claims the benefit of U.S. Provisional Patent Application No. 63/075,806, filed on Sep. 8, 2020, the content of which is hereby incorporated by reference herein in its entirety.

### TECHNICAL FIELD

This disclosure relates generally to electrochemical cells and components thereof, generally that include one or more surface layers that influence one or more properties or performance of the electrochemical cell.

### BACKGROUND

Aluminum-ion batteries can be rechargeable batteries that rely on physical transport of ions between electrodes to transfer charge. Surface layers of electrodes can have appreciable impacts on electrochemistry operation of a battery. That is, for example, surface layers of an electrode can promote or inhibit particular half-cell reactions (e.g., the particular ion acting as a charge transfer species) in a battery. There is a need, therefore, for engineered surface layers and compatible electrolytes that promote favorable electrochemical reactions during charge and discharge of a battery.

### SUMMARY

Described herein are, inter alia, electrochemical cells (e.g., rechargeable batteries). An electrochemical cell may be an energy storage mechanism. An electrochemical cell may be a battery, for example a rechargeable (secondary) battery. A battery (e.g., rechargeable battery) may be an ion battery, such as an aluminum-ion battery or battery that operates using transport of other ions (as discussed subsequently). An electrochemical cell may use redox reactions during operation (e.g., charge and discharge). In some embodiments, an electrochemical cell includes one or more electrodes (e.g., an anode and/or a cathode) that includes a surface layer. The one or more surface layers, as discussed subsequently throughout the disclosure, may be used to affect the electrochemistry of the electrochemical cell, improve performance (e.g., capacity, ion transport), mitigate negative impacts of by-products, and other functions as discussed.

An electrochemical cell may include two electrodes, such as an anode and a cathode, an electrolyte, and, optionally, a separator. An electrochemical cell may include a surface layer. The surface layer may be formed in situ or ex situ and may be grown from or grown into an electrode surface, for example by a pre-treatment, a formation process, and/or during electrochemical cycling. The surface layer may be formed directly on an electrode material, such as an electroactive material or current collector, or on a layer disposed thereon, such as a carbon layer formed by carbonization. A surface layer may be solid or semi-solid, for example a gel or gelatinous. A surface layer may include one or more of: cation(s), anion(s), and functional group(s) that have reacted together, for example to form a gel-like network, for example during electrochemical cycling or a pre-assembly (of the electrochemical cell) formation process or pre-treatment. Cation(s), anion(s), and functional group(s) that are present in a surface layer may have originated from, for example, an electrolyte, an electrode (or other portion of an electrode than the surface layer), or a species (e.g., element or molecule, gas or liquid) that was exposed to an electrode (or portion thereof) prior to electrochemical cell assembly. A surface layer may be a charge storage layer/film or a passivation layer. A surface layer may act as a separator.

An electrode or electrochemical cell that includes a surface layer may include more than one surface layer. For example, different surface layers may be included in or otherwise disposed on or in different electrodes (or portions thereof) in a cell (e.g., one on an anode and one on a cathode) or multiple surface layers may be formed (e.g., by different processes, e.g., at different times) on or in a same electrode (e.g., one before assembly and one during subsequent electrochemical cycling). One surface layer may be formed before carbonization and another one after or multiple surface layers may be formed on a conductive layer (e.g., carbon layer formed by carbonization) (e.g., on different sides of the conductive layer) together after formation of the conductive layer (e.g., post-carbonization).

A surface layer may be formed during a pre-treatment, a formation process, and/or during electrochemical cycling. A formation process may occur after an electrode material has been assembled into a cell. A formation process may involve one or more of (i) environment-controlled ageing of the material in an electrochemical cell (wherein the material is in contact with the electrolyte either at room temperature or at an elevated (e.g., high) temperature) and (ii) electrochemical cycling process, very often at elevated temperature and sometimes incorporating elevated (e.g., high) pressure. The ageing and/or cycling may be repeated, for example either independently (if only one is performed), sequentially (e.g., repeatedly for one then repeatedly for the other), or in alternating fashion (e.g., several times). Electrochemical cycling of a formation process may use cycling conditions (e.g., voltage) separate from normal electrochemical cycling (e.g., as during charge and discharge) of the electrochemical cycling.

This includes specific compounds as one or more of the following: (1) a surface layer on an aluminum structure, (2) a surface layer on a manganese oxide structure, (3) a surface layer on a vanadium oxide structure, (4) as a separator between an anode and a cathode, (5) as an independent anode contributing to reversible storage of charge, and (6) as an independent cathode contributing to reversible storage of charge. The specific compounds of interest include metal phosphates, metal sulfates, metal nitrides, metal nitrates, metal oxides, metal hydroxides, metal oxide hydroxide, and metal carbides, wherein the metals may include magnesium, aluminum, silicon, potassium, calcium, titanium, vanadium, chromium, cerium, manganese, iron, cobalt, nickel, copper, zinc, gallium, zirconium, niobium, molybdenum, ruthenium, indium, tin, tungsten, lead, bismuth, or some combination thereof, aluminates, silicates, and combination thereof.

In some aspects, the present disclosure is directed to an electrochemical cell [e.g., battery (e.g., rechargeable battery)] comprising an anode comprising an aluminum structure (e.g., a foil or film) comprising a surface layer (e.g., disposed thereon or therein) (e.g., having a thickness from 0.1 nm to 100 μm) (e.g., that is a discrete layer or a gradient) comprising (e.g., at least 50 wt. %, at least 70 wt. %, at least 80 wt. %, at least 90 wt. %, or at least 95 wt. % of) a material. The material may comprise (i) one or more monovalent or multivalent atoms and (ii) one or more functional groups. The electrochemical cell may comprise a cathode [e.g., comprising a manganese oxide structured to accommodate insertion (e.g., intercalation) of an ion comprising aluminum (e.g., a polyatomic ion comprising aluminum)]. The electrochemical cell may include an electrolyte disposed in contact with the anode and with the cathode.

In one aspect, the disclosure is directed to an electrochemical cell [e.g., battery (e.g., rechargeable battery, rechargeable ion battery, or rechargeable aluminum battery)] comprising: an anode comprising an aluminum structure (e.g., a foil or film) (e.g., comprising aluminum metal, an aluminum alloy, or an aluminum compound) comprising a surface layer [e.g., disposed thereon or therein (e.g., directly thereon or therein)] (e.g., having a thickness from 0.1 nm to 100 μm) (e.g., that is a discrete layer or a gradient) comprising (e.g., at least 50 wt. %, at least 70 wt. %, at least 80 wt. %, at least 90 wt. %, or at least 95 wt. % of) a material comprising (i) one or more monovalent or multivalent atoms and/or (ii) one or more functional groups; a cathode [e.g., comprising a material (e.g., manganese oxide or vanadium oxide, or both) structured to accommodate reversible storage [e.g., insertion (e.g., intercalation), bond formation, chemical reaction of an ion (e.g., wherein the ion comprises one or more electroactive elements selected from the group consisting of lithium, sodium, potassium, cerium, manganese, rubidium, and aluminum) (e.g., a polyatomic ion, e.g., a polyatomic ion comprising aluminum)]; and an electrolyte disposed in contact with at least one of the anode and the cathode.

In certain embodiments, the one or more monovalent or multivalent atoms are each selected from the group consisting of rare earth metals, transition metals, alkali metals, alkaline earth metals, and main-group elements.

In certain embodiments, the one or more functional groups are each selected from the group consisting of an oxide, a hydroxide, an alkoxide, a peroxide, a superoxide, a nitrate, a nitrite, a sulfate, a sulfite, a sulfide, a carbide, a carbonate, a phosphate, a phosphate, a phosphide, a halide, and combinations thereof.

In certain embodiments, the material has a stoichiometry of M1¹⁺ₓN1ₚN2_{q} or M1²⁺ₓN1ₚN2_{q} or M1³⁺ₓN1ₚN2_{q} or M1⁴⁺ₓN1ₚN2_{q} or M1¹⁺ₓM2²⁺_{y}N1ₚ or M1¹⁺ₓM2³⁺_{y}N1ₚ or M1¹⁺ₓM2⁴⁺_{y}N1ₚ or M1²⁺ₓM2³⁺_{y}N1ₚM1²⁺ₓM2⁴⁺_{y}N1ₚ or M1³⁺ₓM2⁴⁺_{y}N1ₚ or M1¹⁺ₓM2²⁺_{y}N1ₚN2_{q} or M1¹⁺ₓM2³⁺_{y}N1ₚN2_{q} or M1¹⁺ₓM2⁴⁺_{y}N1ₚN2_{q} or M1²⁺ₓM2³⁺_{y}N1ₚN2_{q} or M1²⁺ₓM2⁴⁺_{y}N1ₚN2_{q} or M1³⁺ₓM2⁴⁺_{y}N1ₚN2_{q} or M1¹⁺ₓM2²⁺_{y}M3³⁺_{z}N1ₚ or M1¹⁺ₓM2²⁺_{y}M3⁴⁺_{z}N1ₚ or M1²⁺ₓM2³⁺_{y}M3⁴⁺_{z}N1ₚ or M1¹⁺ₓM2²⁺_{y}M3³⁺_{z}N1ₚN2_{q} or M1¹⁺ₓM2²⁺_{y}M3⁴⁺_{z}N1ₚN2_{q} or M1²⁺ₓM2³⁺_{y}M3⁴⁺_{z}N1ₚN2_{q} or M1¹⁺ₓM2²⁺_{y}M3³⁺_{z}M4⁴⁺ₛN1ₚ or M1¹⁺ₓM2²⁺_{y}M3³⁺_{z}M4⁴⁺ₛN1ₚ N2_{q}, wherein each M (e.g., M1, M2, M3, or M4) is a monovalent or multivalent atom (e.g., as written) and each N (e.g., N1 or N2) is a functional group.

In certain embodiments, the surface layer has a stoichiometry of M1¹⁺ₓM2²⁺_{y}M3³⁺_{z}N1ₚN2_{q}. In certain embodiments, M1 is Na, M2 is Zn, M3 is Al, N1 is Cl, and N2 is OH (e.g., wherein the stoichiometry is Al_{z}³⁺Naₓ¹⁺Zn_{y}²⁺ClₚOH_{q}).

In certain embodiments, the surface layer is a dense film or porous structure.

In certain embodiments, the surface layer is transient [e.g., degrades (e.g., dissolves) and/or reforms (e.g., restructures, redeposits, and/or reorders) during charge and/or discharge].

In certain embodiments, the aluminum structure comprises aluminum having a purity of from 50 wt. % to 99.99999 wt. % on (e.g., directly on) or in which the surface layer is formed. In certain embodiments, the purity is at least 99% (e.g., at least 99.99% or at least 99.99990%).

In certain embodiments, the surface layer comprises water molecules disposed in a crystal structure (e.g., water of hydration).

In certain embodiments, the electrolyte is a solid state electrolyte. In certain embodiments, the electrolyte is a solid polymer electrolyte. In certain embodiments, the solid polymer electrolyte comprises one or more polymers selected from the group consisting of (i) polymers that comprise repeat units of one or more of an ethylene oxide, a propylene oxide, an alizarin, an alginate, a quinones, a hydroxyquinones, a hydroxyquinoline, silicon, a silicate, and a sulfone, (ii) cellulosic, natural or modified natural polymers, and (iii) synthetic fluorinated polymers (e.g., polyvinylidene fluoride (PVDF) and polytetrafluoroethylene (PTFE)).

In certain embodiments, the electrolyte comprises one or more materials each having a stoichiometry of M1¹⁺ₓN1ₚ or M1²⁺ₓN1ₚ or M1³⁺ₓN1ₚ or M1⁴⁺ₓN1ₚ or M1¹⁺ₓN1ₚN2_{q} or M1²⁺ₓN1ₚN2_{q} or M1³⁺ₓN1ₚN2_{q} or M1⁴⁺ₓN1ₚN2_{q} or M1¹⁺ₓM2²⁺_{y}N1ₚ or M1¹⁺ₓM2³⁺_{y}N1ₚ or M1¹⁺ₓM2⁴⁺_{y}N1ₚ or M1²⁺ₓM2³⁺_{y}N1ₚ M1²⁺ₓM2⁴⁺_{y}N1ₚ or M1³⁺ₓM2⁴⁺_{y}N1ₚ or M1¹⁺ₓM2²⁺_{y}N1ₚN2_{q} or M1¹⁺ₓM2³⁺_{y}N1ₚN2_{q} or M1¹⁺ₓM2⁴⁺_{y}N1ₚN2_{q} or M1²⁺ₓM2³⁺_{y}N1ₚN2_{q} or M1²⁺ₓM2⁴⁺_{y}N1ₚN2_{q} or M1³⁺ₓM2⁴⁺_{y}N1ₚN2_{q} or M1¹⁺ₓM2²⁺_{y}M3³⁺_{z}N1ₚ or M1¹⁺ₓM2²⁺_{y}M3⁴⁺_{z}N1ₚ or M1²⁺ₓM2³⁺_{y}M3⁴⁺_{z}N1ₚ or M1¹⁺ₓM2²⁺_{y}M3³⁺_{z}N1ₚN2_{q} or M1¹⁺ₓM2²⁺_{y}M3⁴⁺_{z}N1ₚN2_{q} or M1²⁺ₓM2³⁺_{y}M3⁴⁺_{z}N1ₚN2_{q} or M1¹⁺ₓM2²⁺_{y}M3³⁺_{z}M4⁴⁺ₛN1ₚ or M1¹⁺ₓM2²⁺_{y}M3³⁺_{z}M4⁴⁺ₛN1ₚ N2_{q}, wherein each M (e.g., M1, M2, M3, M4) is a monovalent or multivalent atom and each N (e.g., N1, N2) is a functional group (e.g., selected from the group consisting of a hydroxide, an alkoxide, a peroxide, a superoxide, a nitrate, a nitrite, a sulfate, a sulfite, a sulfide, a carbonate, a phosphate, a phosphate, a phosphide and a halide). In certain embodiments, the one or more materials comprised in the electrolyte form an ion conducting matrix.

In certain embodiments, the electrolyte further comprises one or more of a salt, an acid and a base. In certain embodiments, the electrolyte: (i) comprises the salt, wherein the salt is selected from the group consisting of oxide, hydroxide, alkoxide, peroxide, superoxide, nitrate, nitrite, sulfate, sulfite, sulfide, carbonate, carbide, phosphate, phosphate, phosphide and halide salts of one or more of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, and copper; (ii) comprises the acid, wherein the acid is selected from the group consisting of phosphoric acid, nitric acid, sulfuric acid, hydrochloric acid, sulfurous acid, triflic acid, hydrofluoric acid, peracetic acid, boric acid, uric acid, citric acid, hydroiodic acid, carbonic acid, oxalic acid, bromic acid, chromic acid, formic acid, ascorbic acid, and acetic acid; (iii) comprises the base, wherein the base is selected from the group consisting of hydroxides of sodium, potassium, calcium, magnesium, manganese, lithium, zinc, zirconium, cerium, tin, titanium, aluminum, ammonium, iron, indium, molybdenum, nickel, platinum, palladium, ruthenium, silver, vanadium, and copper; or (iv) any combination of (i), (ii), and (iii).

In certain embodiments, the electrolyte comprises one or more ceramics selected from the group consisting of aluminum oxide, ammonium antimony tungsten oxide, barium titanate, strontium titanate, bismuth strontium calcium copper oxide, boron oxide, boron nitride, ferrites, lead zirconate titanate, magnesium diboride, porcelain, sialon, silicon, silicates, carbide, nitride, titanium carbide, uranium oxide, yttrium barium copper oxide, zinc oxide, cesium oxide, cerium oxide, zirconium oxide, vanadium oxide, tin oxide, iron oxide, tungsten chloride oxide, beryllium oxide, bismuth oxide, lithium oxide, lead oxide, manganese oxide, magnesium oxide, nickel oxide, titanium oxide, cadmium oxide, copper oxide, indium oxide, and silicon oxide.

In certain embodiments, the electrolyte further comprises water molecules disposed in a crystal structure (e.g., water of hydration).

In certain embodiments, the electrolyte is a free standing film or has been applied to the anode or to the cathode.

In certain embodiments, the electrochemical cell has a capacity greater than 200 mAh/g at a charge-discharge rate ranging between C/8 and C/12.

In certain embodiments, the electrochemical cell comprises a porous separator, wherein the porous separator is disposed in the electrolyte between the anode and the cathode thereby preventing physical contact of the anode and the cathode.

In certain embodiments, the aluminum structure [e.g., and/or the cathode (e.g., structure(s) (e.g., particles or film(s))] is coated with carbon [e.g., coated with a film comprising (e.g., of) carbon] or has (e.g., have) carbon interspersed within the structure or both (e.g., as a result of carbonization process).

In certain embodiments, the surface layer is disposed directly in contact with the electrolyte. In certain embodiments, the electrochemical cell comprises a conductive layer (e.g., of carbon), wherein the surface layer is disposed between the aluminum structure and the conductive layer.

In certain embodiments, the surface layer is disposed directly in contact with the aluminum structure.

In certain embodiments, the electrochemical cell comprises a conductive layer disposed between the electrolyte and the surface layer, wherein the surface layer is disposed directly in contact with the aluminum structure.

In certain embodiments, the electrochemical cell further comprises a second surface layer (e.g., subsequently formed after the surface layer) (e.g., wherein the surface layer has been formed by a formation process and the second surface layer has been formed by electrochemical cycling) (e.g., wherein the surface layer and the second surface layer are in direct contact or are not in direct contact) (e.g., wherein one of the surface layer and the second surface layer is a solid layer and the other of the surface layer and the second surface layer is a semi-solid (e.g., gel or gelatinous) layer) (e.g., wherein one of the surface layer and the second surface layer is a passivation layer) (e.g., wherein one of the surface layer and the second surface layer is a charge storage layer).

In certain embodiments, the surface layer is discontinuous.

In certain embodiments, the surface layer is continuous (e.g., and has variable thickness).

In certain embodiments, the surface layer is a passivation layer.

In certain embodiments, the surface layer is a charge storage layer.

In another aspect, the disclosure is directed to a method for forming an anode, the method comprising: providing an aluminum structure (e.g., a metal foil or film comprising aluminum or an aluminum alloy) [e.g., comprising aluminum having a purity in a range from 50 wt % to 99.99999 wt. % (e.g., at least 99.99% or at least 99.9999%)]; and treating the aluminum structure to form a surface layer (e.g., that is a discrete layer or a gradient) (e.g., that is a dense film or porous structure) on or in the aluminum structure, wherein the surface layer comprises a material comprising (i) one or more monovalent or multivalent atoms and (ii) one or more functional groups.

In certain embodiments, treating the aluminum structure to form the surface layer comprises submerging at least a portion of the aluminum structure in a liquid chemical environment.

In certain embodiments, treating the aluminum structure to form the surface layer comprises electrochemical cycling.

In certain embodiments, treating the aluminum structure to form the surface layer comprises submerging the at least a portion of the aluminum structure (e.g., a surface of the aluminum structure) in an acid solution [e.g., a 0.01M to 0.5M acid (e.g., hydrochloric acid, e.g., wherein the chloride is in a neutral state or partially or fully charged state) (e.g., 0.05M to 0.25M acid)] for a period of time (e.g., from 30 mins to 60 mins) at room temperature (e.g., 16-24° C.) (e.g., and optionally subsequently washing the aluminum structure). In certain embodiments, treating the aluminum structure to form the surface layer further comprises, subsequent to the submerging in the acid solution (e.g., and subsequent washing), submerging the aluminum structure (e.g., the surface of the aluminum structure) in a salt solution [e.g., a 0.5M-2M salt solution (e.g., of sodium chloride)] [e.g., for a period of time (e.g., from 30 mins to 60 mins) at room temperature (e.g., 16-24° C.)] (e.g., while applying a negative potential) (e.g., and optionally subsequently washing the aluminum structure). In certain embodiments, treating the aluminum structure to form the surface layer further comprises, subsequent to the submerging in the salt solution, submerging the aluminum structure (e.g., the surface of the aluminum structure) in a base solution [e.g., a 0.5M-2M base solution (e.g., of a hydroxide (e.g., zinc hydroxide), e.g., wherein the hydroxide is in a neutral state or partially or fully charged state)] [e.g., for a period of time (e.g., from 30 mins to 60 mins) at room temperature (e.g., 16-24° C.)] (e.g., while applying a positive potential).

In certain embodiments, the surface layer has a stoichiometry of M1¹⁺ₓM2²⁺_{y}M3³⁺_{z}N1ₚN2_{q}. In certain embodiments, M1 is Na, M2 is Zn, M3 is Al, N1 is Cl, and N2 is OH (e.g., wherein the stoichiometry is Al_{z}³⁺Naₓ¹⁺Zn_{y}²⁺ClₚOH_{q}).

In certain embodiments, the surface layer has been formed by a process according to a method as described herein.

In another aspect, the disclosure is directed to a method for forming an electrode, the method comprising: providing an aluminum structure (e.g., a metal foil or film comprising aluminum or an aluminum alloy) [e.g., comprising aluminum having a purity in a range from 50 wt % to 99.99999 wt. % (e.g., at least 99.99% or at least 99.9999%)]; and forming a surface layer (e.g., that is a discrete layer or a gradient) (e.g., that is a dense film or porous structure) on or in the aluminum structure, wherein the surface layer comprises a material comprising (i) one or more monovalent or multivalent atoms and (ii) one or more functional groups.

In certain embodiments, the forming comprises forming the surface layer by physical vapor deposition, chemical vapor deposition, in situ or ex situ chemical reactions, spray drying, draw-down coating, doctor-blade coating, slot-die coating, comma-coating, or reverse comma-coating.

In another aspect, the disclosure is directed to an electrode (e.g., cathode) for (e.g., in) an electrochemical cell (e.g., a secondary battery, e.g., a secondary ion (e.g., aluminum-ion) battery), the electrode comprising one or more electroactive transition metal oxide structures, wherein the metal in the transition metal oxide is one or a combination of titanium, vanadium, chromium, manganese, iron, cobalt, nickel, copper, zinc, zirconium, molybdenum, and ruthenium.

In certain embodiments, the transition metal oxide further comprises one or more additives and/or dopants, the additives and/or dopants selected from the group consisting of sodium, lithium, potassium, calcium, aluminum, rubidium, cerium, strontium, silicon, gallium, indium, tin, bismuth, titanium, vanadium, chromium, manganese, iron, cobalt, nickel, copper, zinc, zirconium, molybdenum, and ruthenium, carbon, phosphorus, nitrogen, iodine, and boron. In certain embodiments, the one or more additives and/or dopants have been incorporated by wet chemistry comprising use of precursors comprising the one or more additives and/or dopants, physical vapor deposition, chemical vapor deposition, spray drying, hydrothermal reaction, or mixing.

In another aspect, the disclosure is directed to an electrode (e.g., cathode) for (e.g., in) an electrochemical cell (e.g., a secondary battery, e.g., a secondary ion (e.g., aluminum-ion) battery), the electrode comprising one or more electroactive manganese oxide structures, the manganese oxide having stoichiometry comprising MnₓO_{y}, where x is from 1 to 7 and y is from 1 to 7 (e.g., wherein x is from 1 to 3 and y is from 2 to 4) (e.g., wherein different structures and/or different portions of a structure having different stoichiometry for x and y).

In certain embodiments, (i) at least a portion of at least one of the one or more manganese oxide structures is crystalline, (ii) at least a portion of at least one of the one or more manganese oxide structures is amorphous, or (iii) both (i) and (ii) (e.g., wherein at least one of the one or more manganese oxide structures is crystalline or amorphous or at least one is crystalline and at least one is amorphous) (e.g., wherein at least one of the one or more manganese oxide structures is partially crystalline and partially amorphous).

In certain embodiments, at least one of the one or more manganese oxide structures further comprises one or more monovalent or multivalent cations disposed in and/or on the one or more structures. In certain embodiments, the one or more monovalent or multivalent cations are selected from the group consisting of lithium, potassium, calcium, sodium, aluminum, gallium, indium, bismuth, zinc, copper, cerium, lanthanum, rubidium, titanium, iron, tin, lead, vanadium, magnesium, cobalt, chromium, nickel, silver, and combinations thereof. In certain embodiments, the one or more monovalent or multivalent cations are disposed (i) between layers of manganese oxide in the at least one of the one or more manganese oxide structures, (ii) at vacancies in the at least one of the one or more manganese oxide structures, (iii) as one or more pillars extending from the at least one of the one or more manganese oxide structures, (iv) at interstitial voids (e.g., sites, spaces) and/or voids in the at least one of the one or more manganese oxide structures, (v) at defect sites in the at least one of the one or more manganese oxide structures, or (vi) any combination of (i)-(v).

In certain embodiments, at least one of the one or more manganese oxide structures further comprises one or more monovalent or multivalent anions disposed in and/or on the one or more structures. In certain embodiments, the one or more monovalent or multivalent anions are selected from the group consisting of nitrates, sulfates, phosphates, carbonates, halides, nitrites, nitrides, sulfides, sulfates, oxides, hydroxides, oxide-hydroxides, and water crystals. In certain embodiments, the one or more monovalent or multivalent anions are disposed (i) between layers of manganese oxide in the at least one of the one or more manganese oxide structures, (ii) at vacancies in the at least one of the one or more manganese oxide structures, (iii) as one or more pillars extending from the at least one of the one or more manganese oxide structures, (iv) at interstitial voids (e.g., sites, spaces) and/or voids in the at least one of the one or more manganese oxide structures, (v) at defect sites in the at least one of the one or more manganese oxide structures, or (vi) any combination of (i)-(v).

In certain embodiments, the one or more electroactive manganese oxide structures are manganese oxide particles.

In certain embodiments, the one or more electroactive manganese oxide structures have undergone carbonization.

In certain embodiments, the electrode comprises a conductive film coated (e.g., directly) onto the one or more manganese oxide structures.

In certain embodiments, the one or more manganese oxide structures are coated with carbon [e.g., coated with a film comprising (e.g., of) carbon] or have carbon interspersed within the one or more structures or both (e.g., as a result of carbonization process). In certain embodiments, the one or more manganese oxide structures are coated with a film comprising carbon. In certain embodiments, the film is hydrophilic or hydrophobic. In certain embodiments, the film has been formed by a process comprising physical vapor deposition, chemical vapor deposition, in situ or ex situ chemical reactions, spray-drying, draw-down coating, doctor-blade coating, slot-die coating, comma-coating, reverse comma-coating, or a combination thereof. In certain embodiments, the carbonization comprises incorporation of a conductive carbon additive into the manganese oxide. In certain embodiments, the conductive carbon additive is selected from the group consisting of carbon black, carbon nanotubes, graphene sheets, acetylene black, carbon fiber, and combinations thereof. In certain embodiments, the carbonization comprises incorporation of a carbon precursor into the manganese oxide. In certain embodiments, the one or more manganese oxide structures are one or more manganese oxide particles and the carbonization comprises incorporation of the carbon precursor before, during, or after particle synthesis and subsequent carbonization. In certain embodiments, the carbon precursor is selected from the group consisting of a monosaccharide, a disaccharide, an oligosaccharide, a polysaccharide, an organic acid, a polymer, a polyether, an aromatic carbon, and combinations thereof. In certain embodiments, the carbonization comprises a hydrothermal reaction, physical mixing, wet chemistry, electrochemical coating, spray pyrolysis, and spray drying to form a carbon in the one or more manganese oxide species. In certain embodiments, the one or more electroactive manganese oxide structures are coated by a film comprising one or more of manganese, manganese oxide, manganese chloride, manganese nitrate, manganese sulfate, manganese phosphate, manganese hydroxide, or a combination thereof. In certain embodiments, the film is hydrophobic or hydrophilic. In certain embodiments, the film has been formed by a process comprising physical vapor deposition, chemical vapor deposition, in situ or ex situ chemical reactions, spray-drying, draw-down coating, doctor-blade coating, slot-die coating, comma-coating, or reverse comma-coating.

In certain embodiments, the electrode comprises one or more composites that comprise the one or more manganese oxide structures. In certain embodiments, the composite further comprises one or more additional components selected from the group consisting of metals, nitrates, nitrites, nitrides, sulfates, sulfites, sulfides, carbonates, carbides, phosphates, phosphites, acetates, oxides, hydroxides, oxalates, and halides of lithium, potassium, calcium, sodium, aluminum, gallium, indium, bismuth, zinc, copper, cerium, lanthanum, titanium, manganese, iron, tin, lead, vanadium, magnesium, cobalt, chromium, nickel, and silver. In certain embodiments, the one or more additional compounds are from 0.01% to 90% of a total amount (e.g., weight) of the electrode. In certain embodiments, the one or more electroactive manganese oxide structures are one or more primary particles and the one or more composites are one or more secondary particles comprising the one or more primary particles.

In certain embodiments, the one or more composites are formed during chemical, electrochemical, or mechanical synthesis or electrochemical cycling of the primary particles or during chemical, electrochemical, or mechanical synthesis or electrochemical cycling of the secondary particles.

In certain embodiments, the one or more electroactive manganese oxide structures are one or more primary particles and the electrode comprises one or more secondary particles comprising the one or more primary particles.

In certain embodiments, the manganese oxide comprises an exfoliated structure, a delaminated structure, a sheet-like structure, a tunnel structure, a turbostratic structure, a spinel structure, or a combination thereof.

In certain embodiments, the one or more electroactive manganese oxide structures are coated with polymer (e.g., ex situ or in situ) (e.g., wherein the polymer comprises aniline, polyaniline, polypyrrole, or polythiophene).

In certain embodiments, the manganese oxide is structured to accommodate reversible storage [e.g., insertion (e.g., intercalation), bond formation, chemical reaction] of ions, wherein the ions are selected from the group consisting of ions of metals and oxides, hydroxides, oxide-hydroxides, carbonates, nitrates, nitrites, sulfates, sulfides, phosphates, and halides of metals, and combinations thereof, wherein the metals are selected from the group consisting of: lithium, sodium, potassium, cerium, calcium, aluminum, zinc, copper, titanium, chromium, cobalt, rubidium, iron, molybdenum, nickel, vanadium, silicon, manganese, magnesium, silicon, calcium, zirconium, ruthenium, indium, tin, and silver.

In certain embodiments, the manganese oxide is structured to (e.g., further) accommodate reversible insertion of one or more of: water, an oxide, a hydroxide, an oxide-hydroxide, a sulfate, a sulfide, a nitrate, a nitrite, a nitride, a phosphate, a halide, and protons.

In certain embodiments, the electrode is structured to reversibly uptake an electrochemically active monovalent or multivalent ion due, at least in part, to reversible transition of an oxidation state of manganese within the manganese oxide.

In certain embodiments, the electrode is structured to reversibly uptake an electrochemically active monovalent or multivalent ion due, at least in part, to dissolution of manganese in the manganese oxide.

In certain embodiments, the one or more electroactive manganese oxide structures have undergone a structural modification, material property change, or both as a result of a pretreatment process, a formation process [e.g., environment-controlled ageing of the material in an electrochemical cell (e.g., wherein the material is in contact with an electrolyte at room temperature or at an elevated temperature) and/or electrochemical cycling process (e.g., at elevated temperature and/or elevated pressure], or electrochemical cycling, wherein the one or more electroactive manganese oxide structures became electroactive or more electroactive as a result of the structural modification, material property change, or both. In certain embodiments, the structural modification, material property change, or both comprises changing the stoichiometry of the manganese oxide to comprise M_{z}MnₓO_{y}, MnₓO_{y}A_{z}, or M_{z}MnₓO_{y}Aₙ, where M is a cation and A is an anion (e.g., further comprising one or more additional cations and/or anions). In certain embodiments, the structural modification, material property change, or both comprises a change in crystal structure (e.g., to one or a combination of a layered structure (e.g., phyllomanganate), a tunnel structure (e.g., tectomanganate), a spinel, a ramstellite, an amorphous structure, a turbostratic structure, an alpha phase, a beta phase, a delta phase, an epsilon phase, and a gamma phase). In certain embodiments, the structural modification, material property change, or both increasing lattice spacing in the manganese oxide between 0.1 nm and 1 nm (e.g., between 0.2 nm and 0.7 nm). In certain embodiments, the structural modification, material property change, or both results from comproportionation and disproportionation reactions during electrochemical cycling. In certain embodiments, the manganese oxide has undergone the structural modification from the comproportionation and disproportionation during electrochemical cycling, wherein the structural modification is an increase in one or more of vacancies or defects at or adjacent to reaction sites, conversion to or from phyllomanganate to tectomanganate, to or from ordered to disordered, or a crystalline to amorphous transition.

In certain embodiments, the electrode is in contact with an electrolyte and comprises a solid or semi-solid (e.g., gel) interface with the electrolyte. In certain embodiments, the solid or semi-solid interface is an active layer that accommodates reversible storage [e.g., insertion (e.g., intercalation), bond formation, chemical reaction] of ions (e.g., wherein the ions are selected from the group consisting of ions of metals and oxides, hydroxides, oxide-hydroxides, carbonates, nitrates, nitrites, sulfates, sulfides, phosphates, and halides of metals, and combinations thereof, wherein the metals are selected from the group consisting of: lithium, sodium, potassium, cerium, calcium, aluminum, zinc, copper, titanium, chromium, cobalt, rubidium, iron, molybdenum, nickel, vanadium, silicon, manganese, magnesium, silicon, calcium, zirconium, ruthenium, indium, tin, and silver). In certain embodiments, the solid or semi-solid interface is a passivating later that inhibits undesired side reactions. In certain embodiments, the solid or semi-solid interface comprises one or more constituents selected from the group consisting of lithium, sodium, potassium, cerium, calcium, aluminum, zinc, copper, titanium, rubidium, chromium, cobalt, iron, molybdenum, nickel, vanadium, silicon, manganese, magnesium, silicon, calcium, zirconium, ruthenium, indium, tin, silver, carbon, an oxide, a hydroxide, an oxide-hydroxide, a sulfate, a phosphate, a nitrate, a carbide, a carbonate, a sulfide, a phosphide, a nitride, a triflate, a sulfonimide, an oxalatoborate, and combinations thereof.

In certain embodiments, the electrode has been treated with a solution (e.g., an electrolyte) comprising ions selected from the group consisting of ions derived from nickel, copper, bismuth, indium, gallium, tin, tungsten, zinc, an oxide, a hydroxide, carbonates, carbides, nitrates, sulfates, phosphates, acetates, halides, sulfonimides, triflates, tris(trimethylsilyl) borate, citric acid, oxalic acid, tartaric acid, salicylic acid, acetic acid, adipic acid, sebacic acid, boric acid, nitric acid, phosphoric acid, sulfuric acid, hydrochloric acid, and combinations thereof.

In certain embodiments, the electrode has been treated with a solution (e.g., an electrolyte) comprising one or more components selected from the group consisting of lithium bis(trifluoromethanesulfonyl)imide, lithium bis(fluorosulfonyl)imide, potassium bis(trifluoromethanesulfonyl)imide, potassium bis(fluorosulfonyl)imide, sodium bis(trifluoromethanesulfonyl)imide, sodium bis(fluorosulfonyl)imide, aluminum bis(trifluoromethanesulfonyl)imide, aluminum bis(fluorosulfonyl)imide, manganese bis(trifluoromethanesulfonyl)imide, manganese bis(fluorosulfonyl)imide, lithium difluoro(oxalato)borate, lithium tetrafluoroborate, calcium tetrafluoroborate, potassium tetrafluoroborate, sodium tetrafluoroborate, lithium bis(trifluoromethanesulfonate), potassium bis(trifluoromethanesulfonate), calcium bis(trifluoromethanesulfonate), sodium bis(trifluoromethanesulfonate), aluminum bis(trifluoromethanesulfonate), manganese bis(trifluoromethanesulfonate), 1,1,2,2-tetrafluoroethyl-2′,2′,2′-trifluoroethyl ether, boric acid, ammonium tetrafluoroborate, sodium tetrafluoroborate, calcium tetrafluoroborate, potassium tetrafluoroborate, lithium tetrafluoroborate, pyrrole, aniline, vanillin, and thiophene.

In certain embodiments, the electrode is comprised in an electrochemical cell and the treating has occurred prior to incorporation of the electrode into the electrochemical cell.

In certain embodiments, the one or more electroactive manganese oxide structures are at least 50 wt % (e.g., at least 60 wt %, at least 70 wt %, or at least 80 wt %) of the electrode.

In certain embodiments, the electrode comprises a hydrophobic surface (e.g., wherein the hydrophobic surface is inherent or has been obtained through a surface treatment) (e.g., wherein the hydrophobic surface is a surface of the surface layer or another surface of the electrode).

In certain embodiments, the electrode comprises a hydrophilic surface (e.g., wherein the hydrophilic surface is inherent or has been obtained through a surface treatment) (e.g., wherein the hydrophilic surface is a surface of the surface layer or another surface of the electrode).

In certain embodiments, the surface layer is disposed directly in contact with the electrolyte.

In certain embodiments, the electrochemical cell comprises a conductive layer (e.g., of carbon), wherein the surface layer is disposed between the aluminum structure and the conductive layer.

In certain embodiments, the surface layer is disposed directly in contact with the aluminum structure.

In certain embodiments, the electrochemical cell comprises a conductive layer disposed between the electrolyte and the surface layer, wherein the surface layer is disposed directly in contact with the aluminum structure.

In certain embodiments, the electrochemical cell further comprises a second surface layer (e.g., subsequently formed after the surface layer) (e.g., wherein the surface layer has been formed by a formation process and the second surface layer has been formed by electrochemical cycling) (e.g., wherein the surface layer and the second surface layer are in direct contact or are not in direct contact) (e.g., wherein one of the surface layer and the second surface layer is a solid layer and the other of the surface layer and the second surface layer is a semi-solid (e.g., gel or gelatinous) layer) (e.g., wherein one of the surface layer and the second surface layer is a passivation layer) (e.g., wherein one of the surface layer and the second surface layer is a charge storage layer).

In certain embodiments, the surface layer of the electrochemical cell is discontinuous. In certain embodiments, the surface layer of the electrochemical cell is continuous (e.g., and has variable thickness).

In certain embodiments, the surface layer of the electrochemical cell is a passivation layer. In certain embodiments, the surface layer of the electrochemical cell is a charge storage layer.

In another aspect, the disclosure is directed to a method of forming an electrode (e.g., cathode) for (e.g., in) an electrochemical cell (e.g., a secondary battery, e.g., a secondary ion (e.g., aluminum-ion) battery), the method comprising modifying structure, changing one or more material properties, or modifying structure and changing one or more material properties of one or more manganese oxide structures (e.g., particles) to increase electroactivity of the one or more manganese oxide structures.

In certain embodiments, the structural modification, material property change, or both occurs during a pretreatment process, a formation process (e.g., a particle formation process) [e.g., environment-controlled ageing of the material in an electrochemical cell (e.g., wherein the material is in contact with an electrolyte at room temperature or at an elevated temperature) and/or electrochemical cycling process (e.g., at elevated temperature and/or elevated pressure], or electrochemical cycling.

In certain embodiments, the structural modification, material property change, or both comprises changing a stoichiometry of the manganese oxide to incorporate one or more cations and/or one or more anions.

In certain embodiments, the structural modification, material property change, or both comprises changing crystal structure (e.g., to one or a combination of a layered structure (e.g., phyllomanganate), a tunnel structure (e.g., tectomanganate), a spinel, a ramstellite, an amorphous structure, a turbostratic structure, an alpha phase, a beta phase, a delta phase, an epsilon phase, and a gamma phase).

In certain embodiments, the structural modification, material property change, or both comprises increasing lattice spacing in the manganese oxide between 0.1 nm and 1 nm (e.g., between 0.2 nm and 0.7 nm).

In certain embodiments, the structural modification, material property change, or both occurs during comproportionation and disproportionation during electrochemical cycling. In certain embodiments, the structural modification, material property change, or both comprises modifying the structure from the comproportionation and disproportionation during electrochemical cycling, wherein the structural modification is an increase in one or both of vacancies and defects at or adjacent to reaction sites, conversion to or from phyllomanganate to tectomanganate, to or from ordered to disordered, or a crystalline to amorphous transition.

In another aspect, the disclosure is directed to an electrode (e.g., cathode) for (e.g., in) an electrochemical cell (e.g., a secondary battery, e.g., a secondary ion (e.g., aluminum-ion) battery), the electrode comprising one or more electroactive vanadium oxide structures, the vanadium oxide having stoichiometry comprising VₓO_{y}, where x is from 1 to 2 and y is from 2 to 5 when in a form of a stable compound and x is from 1 to 4 and y is from 1 to 9 when in anionic and/or cationic forms (e.g., VO₂⁻¹ or V₃O₄⁻¹).

In certain embodiments, the vanadium oxide comprises one or more crystal structures and the one or more crystal structures are each independently selected from the group consisting of monoclinic, rutile, orthorhombic, and trigonal.

In certain embodiments, the vanadium oxide has been formed to include one or more vacancies, one or more defects, one or more interstitial voids (e.g., sites, spaces), or a combination thereof.

In certain embodiments, at least one of the one or more vanadium oxide structures further comprises one or more monovalent or multivalent cations disposed in and/or on the one or more structures.

In certain embodiments, the one or more monovalent or multivalent cations are selected from the group consisting of lithium, potassium, calcium, sodium, aluminum, gallium, indium, bismuth, zinc, copper, cerium, lanthanum, titanium, rubidium, iron, tin, lead, manganese, magnesium, cobalt, chromium, nickel, silver and combinations thereof.

In certain embodiments, the one or more monovalent or multivalent cations are disposed (i) between layers of vanadium oxide in the at least one of the one or more vanadium oxide structures, (ii) at vacancies in the at least one of the one or more vanadium oxide structures, (iii) as one or more pillars extending from the at least one of the one or more vanadium oxide structures, (iv) at interstitial voids (e.g., sites, spaces) in the at least one of the one or more vanadium oxide structures, (v) at defect sites in the at least one of the one or more vanadium oxide structures, or (vi) any combination of (i)-(v).

In certain embodiments, the one or more electroactive vanadium oxide structures are vanadium oxide particles.

In certain embodiments, the one or more electroactive vanadium oxide structures have undergone carbonization.

In certain embodiments, the one or more vanadium oxide structures are coated with carbon [e.g., coated with a film comprising (e.g., of) carbon] or have carbon interspersed within the one or more structures or both (e.g., as a result of carbonization process). In certain embodiments, the one or more vanadium oxide structures are coated with a film comprising carbon. In certain embodiments, the film is hydrophilic or hydrophobic. In certain embodiments, the film has been formed by a process comprising physical vapor deposition, chemical vapor deposition, in situ or ex situ chemical reactions, spray drying, draw-down coating, doctor-blade coating, slot-die coating, comma-coating, or reverse comma-coating. In certain embodiments, the carbonization comprises incorporation of a conductive carbon additive into the vanadium oxide. In certain embodiments, the conductive carbon additive is selected from the group consisting of carbon black, carbon nanotubes, graphene sheets, acetylene black, carbon fiber, and combinations thereof.

In certain embodiments, the carbonization comprises incorporation of a carbon precursor into the vanadium oxide. In certain embodiments, the one or more vanadium oxide structures are one or more vanadium oxide particles and the carbonization comprises incorporation of the carbon precursor before, during, or after particle synthesis and subsequent carbonization. In certain embodiments, the carbon precursor is selected from the group consisting of a monosaccharide, a disaccharide, an oligosaccharide, a polysaccharide, an organic acid, a polymer, a polyether, an aromatic carbon, and combinations thereof.

In certain embodiments, the carbonization comprises a hydrothermal reaction, physical mixing, wet chemistry, electrochemical coating, spray pyrolysis, and spray drying to form a carbon in the one or more vanadium oxide species.

In certain embodiments, the electrode comprises one or more composites that comprise the one or more vanadium oxide structures. In certain embodiments, the composite further comprises one or more additional compounds selected from the group consisting of metals, nitrates, nitrites, nitrides, sulfates, sulfites, sulfides, carbonates, carbides, phosphates, phosphites, acetates, oxides, hydroxides, oxalates, and halides of lithium, potassium, calcium, sodium, aluminum, gallium, indium, bismuth, zinc, copper, cerium, lanthanum, titanium, rubidium, iron, tin, lead, vanadium, magnesium, cobalt, chromium, nickel, and silver. In certain embodiments, the one or more additional compounds are from 0.01% to 50% of a total amount (e.g., weight) of the electrode. In certain embodiments, the one or more electroactive vanadium oxide structures are one or more primary particles and the one or more composites are one or more secondary particles comprising the one or more primary particles.

In certain embodiments, the one or more composites are formed during chemical, electrochemical, or mechanical synthesis of the primary particles or during chemical, electrochemical, or mechanical synthesis of the secondary particles.

In certain embodiments, the one or more electroactive vanadium oxide structures are one or more primary particles and the electrode comprises one or more secondary particles comprising the one or more primary particles.

In certain embodiments, the vanadium oxide is structured to accommodate reversible insertion of one or more of: lithium, sodium, potassium, cerium, calcium, aluminum, zinc, copper, titanium, rubidium, chromium, cobalt, iron, molybdenum, nickel, vanadium, silicon, manganese, magnesium, silicon, calcium, zirconium, ruthenium, indium, tin, and silver.

In certain embodiments, the one or more electroactive vanadium oxide structures have undergone a structural modification, material property change, or both as a result of a pretreatment process, a formation process [e.g., environment-controlled ageing of the material in an electrochemical cell (e.g., wherein the material is in contact with an electrolyte at room temperature or at an elevated temperature) and/or electrochemical cycling process (e.g., at elevated temperature and/or elevated pressure], or electrochemical cycling, wherein the one or more electroactive vanadium oxide structures became electroactive or more electroactive as a result of the structural modification, material property change, or both. In certain embodiments, the structural modification, material property change, or both comprises changing the stoichiometry of the vanadium oxide to comprise M_{z}VₓO_{y}, VₓO_{y}A_{z}, or M_{z}VₓO_{y}Aₙ, where M is a cation and A is an anion (e.g., further comprising one or more additional cations and/or anions). In certain embodiments, the structural modification, material property change, or both comprises a change in crystal structure (e.g., to one or a combination of a layered structure (e.g., phyllomanganate), a tunnel structure (e.g., tectomanganate), a spinel, a ramstellite, an amorphous structure, a turbostratic structure, an alpha phase, a beta phase, a delta phase, an epsilon phase, and a gamma phase). In certain embodiments, the structural modification, material property change, or both increasing lattice spacing in the vanadium oxide between 0.1 nm and 1 nm (e.g., between 0.2 nm and 0.7 nm).

In certain embodiments, the electrode has been treated with a solution (e.g., an electrolyte) comprising ions selected from the group consisting of ions derived from nickel, copper, bismuth, indium, gallium, tin, zinc, tungsten, nitrates, sulfates, carbonates, carbides, acetates, halides, sulfonimides, triflates, tris(trimethylsilyl) borate, citric acid, oxalic acid, tartaric acid, salicylic acid, acetic acid, adipic acid, sebacic acid, boric acid, nitric acid, phosphoric acid, sulfuric acid, hydrochloric acid, and combinations thereof.

In certain embodiments, the electrode has been treated with a solution (e.g., an electrolyte) comprising one or more components selected from the group consisting of lithium bis(trifluoromethanesulfonyl)imide, lithium bis(fluorosulfonyl)imide, potassium bis(trifluoromethanesulfonyl)imide, potassium bis(fluorosulfonyl)imide, sodium bis(trifluoromethanesulfonyl)imide, sodium bis(fluorosulfonyl)imide, aluminum bis(trifluoromethanesulfonyl)imide, aluminum bis(fluorosulfonyl)imide, manganese bis(trifluoromethanesulfonyl)imide, manganese bis(fluorosulfonyl)imide, lithium difluoro(oxalato)borate, lithium tetrafluoroborate, calcium tetrafluoroborate, potassium tetrafluoroborate, sodium tetrafluoroborate, lithium bis(trifluoromethanesulfonate), potassium bis(trifluoromethanesulfonate), calcium bis(trifluoromethanesulfonate), sodium bis(trifluoromethanesulfonate), aluminum bis(trifluoromethanesulfonate), manganese bis(trifluoromethanesulfonate), 1,1,2,2-tetrafluoroethyl-2′,2′,2′-trifluoroethyl ether, boric acid, ammonium tetrafluoroborate, sodium tetrafluoroborate, calcium tetrafluoroborate, potassium tetrafluoroborate, lithium tetrafluoroborate, pyrrole, aniline, vanillin, and thiophene. In certain embodiments, the electrode is comprised in an electrochemical cell and the treating has occurred prior to incorporation of the electrode into the electrochemical cell.

In certain embodiments, the electrode comprises a hydrophobic surface (e.g., wherein the hydrophobic surface is inherent or has been obtained through a surface treatment) (e.g., wherein the hydrophobic surface is a surface of the surface layer or a surface of the one or more vanadium oxide structures).

In certain embodiments, the electrode comprises a hydrophilic surface (e.g., wherein the hydrophilic surface is inherent or has been obtained through a surface treatment) (e.g., wherein the hydrophilic surface is a surface of the surface layer or a surface of the one or more vanadium oxide structures).

In another aspect, the disclosure is directed to an electrode (e.g., anode) for (e.g., in) an electrochemical cell (e.g., a secondary battery, e.g., a secondary ion (e.g., aluminum-ion) battery), the electrode comprising one or more electroactive vanadium oxide structures, the vanadium oxide having stoichiometry comprising VₓO_{y}, where x is from 1 to 2 and y is from 2 to 5 when in a form of a stable compound and x is from 1 to 4 and y is from 1 to 9 when in anionic and/or cationic forms (e.g., VO₂⁻¹ or V₃O₄⁻¹).

In certain embodiments, the vanadium oxide comprises one or more crystal structures and the one or more crystal structures are each independently selected from the group consisting of monoclinic, rutile, orthorhombic, and trigonal.

In certain embodiments, the vanadium oxide has been formed to include one or more vacancies, one or more defects, one or more interstitial sites, or a combination thereof.

In certain embodiments, the electrode comprises electrochemically active ions disposed in the one or more vanadium oxide structures. In certain embodiments, the ions comprise one or more members selected from the group consisting of ions of magnesium, calcium, aluminum, sodium, potassium, lithium, zinc, iron, tin, titanium, nickel, tungsten, copper, rubidium, cerium, and combinations thereof. In certain embodiments, at least a portion of the electrochemically active ions: (i) are in a metallic form (e.g., Mg, Ca, Al, Na, K, Li, Zn, Fe, Sn, Ti, or Ni), (ii) are a metal complexes (e.g., Mg(OH)₂, Ca(NO₃)₂, or combinations thereof), or (iii) are in a partially charged state (e.g., Al(OH)₄⁻¹) (e.g., wherein each of at least two (e.g., at least three) portions of the electrochemically active ions are independently one of (i), (ii), and (iii)).

In certain embodiments, the electrode comprises a conductive (e.g., metallic) film coated (e.g., directly) onto the one or more vanadium oxide structures.

In certain embodiments, the one or more vanadium oxide structures are one or more vanadium oxide particles.

In certain embodiments, the vanadium oxide is an alloy or mixture in combination with one or more members selected from the group consisting of a transition metal oxide, a transition metal sulfide, a metal oxide, a metal sulfide, a metal carbide, or a metal, wherein the metal comprises one or more of: lithium, potassium, calcium, sodium, aluminum, zinc, titanium, iron, tin, vanadium, rubidium, cerium, tungsten, magnesium, cobalt, chromium, nickel, platinum, gold, and silver.

In certain embodiments, the one or more vanadium oxide structures has undergone a carbonization process.

In certain embodiments, the electrode comprises a surface layer formed on the one or more vanadium oxide structures during a pretreatment process, a formation process [e.g., environment-controlled ageing of the material in an electrochemical cell (e.g., wherein the material is in contact with an electrolyte at room temperature or at an elevated temperature) and/or electrochemical cycling process (e.g., at elevated temperature and/or elevated pressure], or electrochemical cycling.

In certain embodiments, the surface layer has been formed bottom up extending from a surface of the one or more vanadium oxide structures.

In certain embodiments, the surface layer has been formed top down extending into a surface of the one or more vanadium oxide structures.

In certain embodiments, the surface layer comprises an ordered layer structure, a disordered layer structure, or both.

In certain embodiments, the surface layer comprises one or more (e.g., at least one and no more than two) multivalent elements selected from the group consisting of aluminum, zinc, copper, titanium, chromium, cobalt, iron, molybdenum, nickel, vanadium, manganese, magnesium, silicon, calcium, cerium, rubidium, zirconium, ruthenium, indium, tin, silver, gold, and platinum.

In certain embodiments, the surface layer comprises one or more anions or molecules selected from the group consisting of hydroxides, oxides, oxide hydroxides, triflates, sulfonimides, oxalatoborates, acetates, nitrates, sulfates, nitrites, phosphates, sulfides, nitrides, combinations thereof, and decomposition products of one or more thereof.

In certain embodiments, the surface layer further comprises one or more of silicon, silicon monoxide, silicon dioxide, silicates, and water crystals.

In certain embodiments, the vanadium oxide is structured to accommodate reversible insertion of one or more of: lithium, sodium, potassium, calcium, cerium, aluminum, zinc, copper, titanium, chromium, cobalt, iron, molybdenum, nickel, vanadium, silicon, manganese, magnesium, silicon, cerium, rubidium, calcium, zirconium, ruthenium, indium, tin, and silver.

In certain embodiments, the electrode is structured to reversibly uptake an electrochemically active monovalent or multivalent ion due, at least in part, to reversible transition of an oxidation state of vanadium within the vanadium oxide.

In certain embodiments, the electrode is structured to reversibly uptake an electrochemically active monovalent or multivalent ion due, at least in part, to dissolution of vanadium in the vanadium oxide.

In another aspect, the disclosure is directed to a separator in an electrochemical cell (e.g., a secondary battery, e.g., a secondary ion (e.g., aluminum-ion) battery) comprising an electrolyte disposed between two electrodes, the separator comprising a solid or semi-solid (e.g., gel) layer formed from a portion of the electrolyte and/or a portion of at least one of the electrodes (e.g., having particles dispersed therein).

In certain embodiments, the separator has been formed by electrochemical cycling of the electrochemical cell.

In certain embodiments, the separator has been formed bottom up on one of the electrodes.

In certain embodiments, the separator has been formed top down into one of the electrodes.

In certain embodiments, the separator comprises one or more ions derived from a member selected from the group consisting of oxides, oxide-hydroxides, hydroxides, sulfates, sulfides, nitrates, nitrides, nitrites, phosphates, halides, triflates, sulfonimides, oxalatoborates, acetates, and decomposition products of the former and magnesium, calcium, cerium, aluminum, sodium, potassium, lithium, zinc, rubidium iron, tin, manganese, magnesium, silicon, titanium, silver, gold, and nickel, respectively.

In certain embodiments, the separator is an ion permeable passivating layer.

In certain embodiments, the separator comprises one or more of: sodium, potassium, calcium, iron, aluminum, silicon, tin, titanium, manganese, magnesium, zinc, nickel, zirconium, carbon, cerium, rubidium, nitrates, nitrites, sulfates, nitrides, oxides, hydroxides, oxide-hydroxies, aluminates, silicates, sulfides, triflates, sulfonimides, oxalatoborates, phosphates, oxides, hydroxides, oxide hydroxides, water, and a combination thereof.

In certain embodiments, one of the two electrodes is a cathode and the separator has been formed at the cathode during electrochemical cycling.

In another aspect, the disclosure is directed to a separator comprising a layer coated onto an electrode for an electrochemical cell (e.g., a secondary battery, e.g., a secondary ion (e.g., aluminum-ion) battery) comprising particles (e.g., wherein the particles comprise powdered particles, ordered or disordered structures, spheres, sheets, fibers, pillars, particles that are a combination thereof, or combinations thereof).

In certain embodiments, the particles are ion conductors.

In certain embodiments, the separator further comprises a polymer, wherein the particles are dispersed in the polymer (e.g., forming a polymer matrix).

In certain embodiments, the separator has been calendared onto the electrode.

In certain embodiments, the separator has been annealed.

In certain embodiments, the separator is in contact with a liquid electrolyte.

In certain embodiments, the separator is an electrochemically active layer (e.g., structured to store and release ions in at least a portion of the separator).

In certain embodiments, the separator is hydrophobic (e.g., inherently or as a result of a surface treatment) (e.g., wherein a surface of the separator is hydrophobic).

In certain embodiments, the separator is hydrophobic (e.g., inherently or as a result of a surface treatment) (e.g., wherein a surface of the separator is hydrophobic).

In another aspect, the disclosure is directed to an electrochemical cell as described herein, comprising the separator, wherein the separator is an electrochemically active layer in the electrochemical cell.

In another aspect, the disclosure is directed to an electrochemical cell comprising the separator as described herein and further comprising a second separator (e.g., comprising pores of a size corresponding to one or more ions).

In certain embodiments, the second separator comprises one or more materials selected from the group consisting of PVDF, cellulose, nylon, sulfones, polyurethanes, polypropylene, ceramics (e.g., silica, alumina, silicates), and aluminates.

In another aspect, the disclosure is directed to an (e.g., aqueous) electrolyte for (e.g., in) an electrochemical cell (e.g., a secondary battery, e.g., a secondary ion (e.g., aluminum-ion) battery), the electrolyte comprising at least one solvent and at least one salt, wherein each of the least one solvent is selected from the group consisting of ethylene carbonate, butylene carbonate, fluoroethylene carbonate, vinylene carbonate, sulfolane, gamma-butyrolactone, dimethyl carbonate, diethyl carbonate, dipropyl carbonate, dibutyl carbonate, ethyl methyl carbonate, methyl propyl carbonate, ethyl propyl carbonate, propylene carbonate, acetonitrile, isopropanol, ethanol, methanol, 1-propanol, 1,2-dimethoxyethane, dimethyl sulfoxide, acetic acid, sulfuric acid, nitric acid, phosphoric acid, boric acid, aniline, and water.

In certain embodiments, each of the at least one salt is a member selected from the group consisting of hydroxides, sulfates, phosphates, halides, nitrates, nitrites, nitrides, carbides, triflates, sulfonimides, and oxalatoborates of lithium, sodium, potassium, calcium, magnesium, strontium, cerium, rubidium, titanium, vanadium, chromium, manganese, iron, cobalt, nickel, copper, zinc, aluminum, silicon, zirconium, silver, cadmium, indium, tin, and tungsten.

In certain embodiments, the electrolyte comprises a buffer solution, wherein pH of the electrolyte is maintained from 1 to 10 (e.g., from 2 to 6) by the buffer solution. In certain embodiments, the buffer solution comprises weak acid buffer or basic buffer.

In certain embodiments, the buffer solution comprises one or more of: sodium phosphate-citric acid, sodium citrate-citric acid, and sodium acetate-acetate acid.

In certain embodiments, the buffer solution comprises one or more of: glycine-sodium hydroxide and monosodium phosphate-disodium phosphate.

In certain embodiments, the electrolyte is an aqueous electrolyte and further comprises one or more anionic surface active agents selected from the group consisting of sodium dodecylsulfate, sodium decylsulfate, ammonium lauryl sulfate, sodium laureth sulfate, sodium lauryl sarcosinate, sodium myreth sulfate, sodium pareth sulfate, sodium stearate, sodium lauryl sulfate, ammonium laureth sulfate, sodium N-lauroyl-N-methyltaurate, sodium tetradecyl sulfate, sodium dodecylsulfonate, sodium dodecylbenzenesulfonate, and sodium dialkylsulfosuccinate. In certain embodiments, the one or more anionic surface-active agents are present in the electrolyte in a concentration of from 0.1 μM to 10 M (e.g., from 0.1 μM to 1 M).

In certain embodiments, the electrolyte is an aqueous electrolyte and further comprises one or more nonionic surface active agents selected from the group consisting of Triton X-100, Triton X-45, Triton X-165, Triton X-305, Triton X-405, Triton CF-32, Polysorbate 20, Span 80, Tergitol 15-S-3, Tergitol 15-S-9, Brij-35, Tetronic 150R1, and Pluronic F68. In certain embodiments, the one or more nonionic surface-active agents are present in the electrolyte in a concentration of from 0.1 μM to 10 M (e.g., from 0.1 μM to 5 M).

In certain embodiments, the electrolyte is an aqueous electrolyte and further comprises one or more zwitterionic surface active agents selected from the group consisting of cocamidopropyl betaine, amidosulfobetaine-16, lauryl-N,N-(dimethylammonio)butyrate, lauryl-N,N-(dimethyl)-glycinebetaine, 3-[(3-cholamidopropyl)dimethylammonio]-1-propanesulfonate, 3-([3-cholamidopropyl]dimethylammonio)-2-hydroxy-1-propanesulfonate, 3-[(3-cholamidopropyl)dimethylammo-nio]-1-propanesulfonate, lauryl-N,N-(dimethyl)-propanesulfonate, 3-(4-tert-butyl-1-pyridinio)-1-propanesulfonate, 3-(1-pyridinio)-1-propanesulfonate, 3-(benzyl-dimethylammonio)propanesulfonate, and lauryldimethylamine N-oxide. In certain embodiments, the one or more zwitterionic surface active agents are present in the electrolyte in a concentration of from 0.1 μM to 10 M (e.g., from 0.1 μM to 5 M).

In certain embodiments, the electrolyte is an aqueous electrolyte and further comprises one or more cationic surface-active agents selected from the group consisting of cetyl trimethyl ammonium bromide, trimethylammoniumhexadecyl chloride, alkyldimethylbenzyl ammonium chloride, dodecyltrimethylammonium bromide, dodecyltrimethylammonium bromide, and 1-dodecylpyridinium bromide. In certain embodiments, the one or more cationic surface-active agents are present in the electrolyte in a concentration of from 0.1 μM to 10 M (e.g., from 0.1 μM to 5 M).

In certain embodiments, the electrolyte is an aqueous electrolyte and further comprises one or more organic additives and/or inorganic additives selected from the group consisting of ammonium borate, sodium silicate, 30,60-dihydroxyspiro[2-benzofuran-3,90-xanthene]-1-one, (E)-4-((2 chlorophenyl)diazenyl)naphthalene-1,5-diol, (E)-4-(o-tolyldiazenyl)naphthalene-1,5-diol, and (E)-4-((2 methoxyphenyl)diazenyl)naphthalene-1,5-diol, N-thiazolyl-2-cyanoacetamide derivatives, (e.g., N-(4-phenylthiazol-2-yl)-2-phenylazo-2-cyanoacetamide, N-(4-phenylthiazol-2-yl)-2-(p-tolylazo)-2-cyanoacetamide, and N-(4-phenylthiazol-2-yl)-2-(p-methoxyphenylazo)-2-cyanoacetamid, 1-(4-((2-hydroxy-3 nitrophenyl)diazenyl)phenyl)propan-1-one, 1-(4-((3-amino-2-hydroxyphenyl)diazenyl)phenyl)propan-1-one, and 1-(4-((2,4,6-trihydroxyphenyl)diazenyl)phenyl)propan-1-one), 50-amino-2,4-dihydroxy-400-methyl-1,10:30,100-terphenyl-40,60-dicarbonitrile (ABDN-1), 50-amino-2,200,4-trihydroxy-1,10:30,100-terphenyl-40,60-dicarbonitrile (ABDN-2), and 50-amino-2,4,400-trihydroxy-300-methoxy-1,10:30,10-terphenyl-40,60-dicarbonitrile (ABDN-3), polyoxyethylene (20) sorbitanmonooleate (Tween 80), 3-ethyl-4-amino-mercapto-1,2,4-triazole, 3-methyl-4-amino-5-mercapto-1,2,4-triazole (MAMT), 3-(4-hydroxy-3-methoxy-phenyl)-1-(2-hydroxy-phenyl)-propenone (HMPHPP), 1-(4-hydroxyphenyl)-3-(2-hydroxyphenyl)-propenone (HPHPP), 2-propanol, 3-methylpyridine, crystal violet dye, -(4-nitrophenylazo)-1-naphthol (44NIN), 8-hydroxyquinoline (8-HQ), polymethacrylate, amino-1,2,4-triazole-5-thiol (ATAT), tryptamine, tryptophane, monoethanolamine (MEA), o-phenylenediamine, anthranilic, ferrous gluconate, calcium gluconate, diisopropyl thiourea (DISOTU), cerium dibutylphosphate, licylaldoxime (SAL), 2-mercaptobenzothiazole, 8-HQ, thioacetamide, quinaldic acid, a-benzoionoxime, 2-(2-hydroxyphenyl) benzoxazole, dithioox-amide, cuprizone, and cupferron, dimercapto-1,3,4-thiadiazolate (DMTD), 1,2,4-triazole (TA), 3-amino-1,2,4-triazole (ATA), benzotriazole (BTA), and 2-mercaptobenzothiazole (2-MBT), butine-1,4-diol and potassium sodium tartrate, propargyl alcohol, 8-aminoquinoline (8-AQ) and 8-nitroquinoline (8-NQ), pyrrolidine dithio-carbamate (PDTC), benzamide (BA), 4-aminobenzenesulfonamide (ABSA), and thioacetamide (TAA). In certain embodiments, the one or more organic additives and/or inorganic additives are present in the electrolyte in a concentration of from 50 ppm to 10 M (e.g., from 50 ppm to 1 M).

In certain embodiments, the electrolyte is an aqueous electrolyte and further comprises one or more metal oxides, wherein the metal in the one or more metal oxides comprises one or more members selected from the group consisting of zinc, iron, aluminum, cerium, titanium, rubidium, bismuth, indium, barium, cobalt, nickel, copper, zirconium, niobium, tantalum, manganese, tin, indium, chromium, lead, and tungsten. In certain embodiments, the one or more metal oxides are present in the electrolyte in a concentration of from 0.01 to 20 g/L.

In certain embodiments, the electrolyte is an aqueous electrolyte and further comprises one or more additives selected from the group consisting of bismuth nitrate, indium nitrate, gallium nitrate, sodium carboxymethylcellulose, tris(trimethylsilyl) borate, P-nitrophenol, citric acid, oxalic acid, tartaric acid, salicylic acid, acetic acid, adipic acid, sebacic acid, boric acid, nitric acid, phosphoric acid, sulfuric acid, hydrochloric acid, and nitric acid. In certain embodiments, the one or more additives are present in the electrolyte in a concentration of from 1 mM to 10 M (e.g., from 1 mM to 1 M).

In certain embodiments, the at least one solvent comprises two or more solvents selected from the group consisting of water, methanol, isopropanol, ethanol, sulfolane, acetonitrile, succinonitrile, dimethylsulfoxide, tetrahydrofuran, toluene, propylene carbonate, benzene, dichloromethane, dimethylformamide, nitrobenzene, dichlorobenzene, ethylene glycol, 1,1,2,2-tetrafluoroethyl-2′,2′,2′-trifluoroethyl ether, and diethyl carbonate.

In another aspect, the disclosure is directed to_an electrochemical cell (e.g., a secondary battery, e.g., a secondary ion (e.g., aluminum-ion) battery) comprising: two electrodes; an electrolyte; and a charge storage surface film, wherein the surface film is disposed (i) on at least one of the two electrodes, (ii) between the two electrodes, and (iii) in contact with the electrolyte.

In certain embodiments, the surface film was formed on the at least one of the two electrodes (e.g., grew from each of the two electrodes into a common surface film for the two electrodes).

In certain embodiments, the surface film was formed during electrochemical cycling.

In certain embodiments, the surface film was formed ex situ and deposited on the at least one of the two electrodes (e.g., by wet chemical reaction, physical vapor deposition, chemical vapor deposition, atomic layer deposition, sintering, pressing, hot pressing, extrusion, die casting, slot-die coating, doctor-blade coating, comma-coating, or reverse comma-coating). In certain embodiments, the surface film comprises a mixture comprising conductive carbon and polymer binder. In certain embodiments, the surface film comprises one or more members selected from the group consisting of sodium, potassium, calcium, iron, aluminum, silicon, tin, carbon, titanium, manganese, vanadium, magnesium, zinc, cerium, rubidium, tungsten, nickel, zirconium, carbon, nitrates, sulfates, nitrides, nitrites, carbides, carbonates, sulfides, triflates, sulfonimides, oxalatoborates, phosphates, oxides, hydroxides, oxide hydroxides, and water. In certain embodiments, the surface film comprises one or more compounds formed from the one or more members.

In certain embodiments, the surface film is a solid layer with a thickness in a range from 10 nm to 1 mm (e.g., from 1 μm to 300 μm).

In certain embodiments, the surface film is a gelatinous layer with a thickness in a range from 10 nm to 1 mm (e.g., from 1 μm to 300 μm).

In certain embodiments, the surface film is structured to accommodate insertion of ions (i) within the film (e.g., in vacancies, interstitial sites, defect sites), (ii) through an ion exchange reaction, or (iii) both (i) and (ii).

In certain embodiments, the surface film has been formed by a process comprising: forming ions in an aqueous solution (e.g., wherein the electrolyte is the aqueous solution) by ionizing a species in the anode, the cathode, the electrolyte, or a combination thereof; creating solvation shell for the ions; and chain reacting the ions by sharing a functional group between the solvation shells. In certain embodiments, the surface film is gelatinous due to the chain reacting.

In certain embodiments, the electrochemical cell comprises one or more guest ions disposed in the surface film, wherein the surface film is a gelatinous layer. In certain embodiments, the one or more guest ions are selected from the group consisting of sodium, potassium, calcium, iron, aluminum, silicon, tin, titanium, manganese, magnesium, zinc, nickel, cerium, rubidium, tungsten, bismuth, zirconium, and protons.

In certain embodiments, the surface film comprises one or more functional groups, wherein each of the one or more functional groups is selected from the group consisting of nitrates, sulfates, nitrides, sulfides, nitrites, carbides, triflates, halides, sulfonimides, oxalatoborates, phosphates, oxides, hydroxides, and oxide hydroxides

In certain embodiments, the surface film is a solid layer.

In certain embodiments, the surface layer comprises a hydrophobic surface (e.g., wherein the hydrophobic surface is inherent or has been obtained through a surface treatment).

In certain embodiments, the surface layer comprises a hydrophilic surface (e.g., wherein the hydrophilic surface is inherent or has been obtained through a surface treatment).

In certain embodiments, the surface film is discontinuous.

In certain embodiments, the surface film is continuous (e.g., and has variable thickness).

In another aspect, the disclosure is directed to a method of forming a charge storage surface film in an electrochemical cell comprising an anode, a cathode, and an electrolyte, the method comprising: forming ions in an aqueous solution (e.g., wherein the electrolyte is the aqueous solution) by ionizing a species in the anode, the cathode, the electrolyte, or a combination thereof; creating solvation shell for the ions; and chain reacting the ions by sharing a functional group between the solvation shells.

In certain embodiments, the functional group is selected from the group consisting of nitrates, sulfates, nitrides, sulfides, nitrites, carbides, triflates, halides, sulfonimides, oxalatoborates, phosphates, oxides, hydroxides, and oxide hydroxides.

In certain embodiments, the method comprises stabilizing charge of the ions by coordination through dipoles in water in the aqueous solution.

In certain embodiments, the method comprises controlling the solvation cell by adjusting pH of the aqueous solution (e.g., of the electrolyte) and/or applied potential (e.g., during electrochemical cycling) (e.g., prior to forming the ions).

In certain embodiments, the method comprises forming a gelatinous layer comprised in the charge storage surface film, wherein forming the gelatinous layer comprises the chain reacting of the ions.

In certain embodiments, the method comprises controlling size and orderliness of constituents in the surface layer by adjusting temperature, ageing, and pH of the aqueous solution (e.g., of the electrolyte) (e.g., prior to forming the ions).

In another aspect, the disclosure is directed to an electrochemical cell (e.g., a secondary battery, e.g., a secondary ion (e.g., aluminum-ion) battery) comprising: two electrodes (e.g., a cathode and an anode); an electrolyte; and a solid or semi-solid (e.g., gel or gelatinous layer) surface layer (e.g., film), wherein the surface layer is disposed on (e.g., comprised in) at least one of the two electrodes between the two electrodes and is in contact with the electrolyte.

In certain embodiments, the surface layer comprises one or more constituents selected from the group consisting of sodium, potassium, calcium, iron, aluminum, silicon, tin, titanium, manganese, magnesium, zinc, nickel, cerium, tungsten, rubidium, zirconium, carbon, nitrates, sulfates, nitrides, sulfides, nitrites, sulfites, carbides, triflates, sulfonimides, oxalatoborates, phosphates, oxides, hydroxides, oxide hydroxides, and water.

In certain embodiments, the two electrodes are an anode and a cathode and the surface layer has formed at the cathode during electrochemical cycling.

In certain embodiments, the surface layer comprises one or more organic soft materials, one or more inorganic soft materials, or both.

In certain embodiments, the surface layer is formed of constituents derived from the electrolyte and/or at least one of the two electrodes.

In certain embodiments, the electrochemical cell comprises gas disposed within the surface layer. In certain embodiments, the gas is a by-product of electrochemical cycling of the electrochemical cell.

In certain embodiments, the surface layer has been ionized. In certain embodiments, the surface layer has been ionized by a redox reaction with the gas.

In certain embodiments, the gas comprises one or more of: nitrogen, oxygen, a halide, sulfur, hydrogen, a derivative thereof (e.g., nitrogen oxide, sulfur oxide, or water vapor) or a combination thereof.

In certain embodiments, the electrolyte is an aqueous electrolyte.

In certain embodiments, the surface layer has been ionized.

In certain embodiments, the surface layer comprises a hydrophobic surface (e.g., wherein the hydrophobic surface is inherent or has been obtained through a surface treatment).

In certain embodiments, the surface layer comprises a hydrophilic surface (e.g., wherein the hydrophilic surface is inherent or has been obtained through a surface treatment).

In another aspect, the disclosure is directed to a method of controlling presence of gas in an electrochemical cell, the method comprising: providing the electrochemical cell, the electrochemical cell comprising (i) two electrodes, (ii) a liquid (e.g., aqueous) electrolyte; and (iii) a semi-solid (e.g., gel or gelatinous layer) surface layer (e.g., film), wherein the surface layer is disposed on (e.g., comprised in) at least one of the two electrodes between the two electrodes and is in contact with the electrolyte; generating gas between the two electrodes [e.g., between two surface layers on different electrodes, between a surface layer and an electrode, on an electrode surface without a surface layer (e.g., wherein an opposing electrode has a surface layer disposed thereon or therein)]; and reacting the gas with the semi-solid surface layer thereby eliminating at least a portion of the gas.

In certain embodiments, the gas is a by-product of electrochemical cycling of the electrochemical cell (e.g., is an evolved gas).

In certain embodiments, the gas comprises one or more of: nitrogen, oxygen, a halide, sulfur, and hydrogen, or a derivative of these including but not limited to nitrogen oxide, sulfur oxide, water vapor.

In certain embodiments, the method comprises harvesting leakage electrons in the gas by a redox reaction with the semi-solid layer and the gas.

In certain embodiments, the reacting the gas with the semi-solid surface layer comprises reacting the gas with one or more constituents in the semi-solid surface layer, the one or more constituents selected from the group consisting of sodium, potassium, calcium, iron, aluminum, tin, titanium, manganese, magnesium, zinc, nickel, zirconium, cerium, rubidium, tungsten, carbon, nitrates, sulfates, nitrides, sulfides, nitrites, sulfites, carbides, triflates, sulfonimides, oxalatoborates, phosphates, oxides, hydroxides, oxide hydroxides, and water.

In certain embodiments, the method comprises temporarily storing the gas in the semi-solid surface layer. In certain embodiments, the reacting the gas eliminates the temporarily stored gas.

In certain embodiments, the gas is disposed in the semi-solid surface layer as one or more bubbles. In certain embodiments, motion of the one or more bubbles is inhibited by the semi-solid surface layer (e.g., due to the semi-solid surface layer being a gel or being gelatinous). In certain embodiments, the method comprises nucleating at least one of the one or more bubbles at an interface between the semi-solid surface layer and one of the electrodes comprised in the at least one of the two electrodes (e.g., wherein the bubble(s) is/are nucleated from gas dispersed in the one of the electrodes). In certain embodiments, the reacting the gas with the semi-solid surface layer shrinks the one or more bubbles (e.g., through chemical binding or one or more electrical pathways in the semi-solid surface layer).

In certain embodiments, the reacting the gas with the semi-solid surface layer comprises capturing (e.g., reversibly) hydrogen ions, sulfur ions, sulfur oxide ions, nitrogen oxide ions, hydronium ions, oxygen ions, or a combination thereof. In certain embodiments, the method comprises subsequently reacting the hydrogen ions, sulfur ions, sulfur oxide ions, nitrogen oxide ions, hydronium ions, oxygen ions, or combination thereof with one or more constituents in the semi-solid surface layer, the one or more constituents selected from the group consisting of sodium, potassium, calcium, iron, aluminum, tin, titanium, manganese, magnesium, zinc, cerium, rubidium, tungsten, nickel, zirconium, carbon, nitrates, sulfates, nitrides, sulfides, nitrites, sulfites, carbides, triflates, sulfonimides, oxalatoborates, phosphates, oxides, hydroxides, oxide hydroxides, and water.

In certain embodiments, the method comprises inducing the reacting the gas with the semi-solid surface layer by applying a polarization pulse (e.g., a short polarization pulse of no more than 2 min and no less than 10 ms).

In certain embodiments, the polarization pulse is applied during charge or discharge of the electrochemical cell.

In certain embodiments, the method comprises initiating the reacting the gas with the semi-solid surface layer (e.g., initiating shrinking of a bubble of the gas) by applying an opposite electrical polarization (e.g., discharge).

In certain embodiments, the reacting the gas comprises electrochemical decomposition of the gas.

In certain embodiments, the reacting the gas occurs during charge, discharge, or both charge and discharge of the electrochemical cell.

In certain embodiments, the reacting the gas comprises a protonation reaction with the gas. In certain embodiments, the capturing hydrogen or hydronium ions from the gas as a result of the protonation reaction.

In another aspect, the disclosure is directed to an anode for an electrochemical cell (e.g., a secondary battery, e.g., a secondary aluminum battery), the anode comprising a metal (e.g., a metal foil), metallic alloy, or metallic compound (e.g., as a film, layer, or particles) comprising one or more monovalent or multivalent elements that is disposed (e.g., coated) on the substrate.

In certain embodiments, the one or more monovalent or multivalent elements are selected from the group consisting of lithium, sodium, potassium, calcium, cerium, aluminum, zinc, copper, titanium, chromium, cobalt, iron, molybdenum, tungsten, carbon, nickel, vanadium, silicon, manganese, magnesium, silicon, calcium, zirconium, ruthenium, indium, tin, gallium, bismuth, silver, gold, and platinum.

In certain embodiments, the metal, metallic alloy, or metallic compound comprises one or more selected from the group consisting of metal phosphates, metal sulfates, metal nitrides, metal nitrates, metal nitrides, metal oxides, metal carbides, metal hydroxides, metal oxide hydroxide, aluminates, silicates, metal carbides, and combination thereof.

In certain embodiments, the metal, metallic alloy, or metallic compound is disposed (e.g., coated) on a current collector [e.g., by a vapor deposition process (e.g., physical vapor deposition, chemical vapor deposition, atomic layer deposition, a wet coating process (e.g., in situ or ex situ), spray drying, draw-down, doctor-blade, slot-die, comma-coating, or reverse comma-coating)].

In certain embodiments, the anode comprises conductive carbon and/or polymer binder.

In certain embodiments, the anode comprises a surface layer [e.g., a solid or semi-solid (e.g., gel or gelatinous layer)] formed on the metal, metallic alloy, or metallic compound during a pretreatment process, a formation process [e.g., environment-controlled ageing of the material in an electrochemical cell (e.g., wherein the material is in contact with an electrolyte at room temperature or at an elevated temperature) and/or electrochemical cycling process (e.g., at elevated temperature and/or elevated pressure], or electrochemical cycling [e.g., an interphase passivating layer (e.g., that is permeable to one or more monovalent or multivalent ions)].

In certain embodiments, the surface layer has been formed bottom up extending from a surface of the metal, metallic alloy, or metallic compound.

In certain embodiments, the surface layer has been formed top down extending (e.g., growing) into a surface of the metal, metallic alloy, or metallic compound.

In certain embodiments, the surface layer comprises an ordered layer structure, a disordered layer structure, or both.

In certain embodiments, the surface layer comprises one or more (e.g., at least one and no more than two) monovalent or multivalent elements selected from the group consisting of lithium, sodium, potassium, calcium, cerium, boron, tungsten, aluminum, zinc, copper, titanium, chromium, cobalt, carbon, iron, molybdenum, nickel, rubidium, vanadium, silicon, manganese, magnesium, silicon, calcium, zirconium, ruthenium, indium, tin, silver, gold, and platinum.

In certain embodiments, the surface layer comprises one or more anions or molecules selected from the group consisting of hydroxides, oxides, oxide hydroxides, nitrates, sulfates, carbides, phosphates, sulfides, triflates, sulfonimides, oxalatoborates, acetates, nitrides, nitrites, sulfites, combinations thereof, and decomposition products of one or more thereof.

In certain embodiments, the surface layer further comprises one or more or a combination of silicon, silicon oxide, aluminum, aluminum oxide, and water crystals.

In certain embodiments, the surface layer comprises a multivalent element and a monovalent element selected from the group consisting of lithium, sodium, potassium, rubidium, and cerium.

In certain embodiments, the surface layer is structured to host and release ions (e.g., cations and/or anions) (e.g., involved in an electrochemical reaction in the electrochemical cell) (e.g., wherein the ions are electroactive ions, e.g., that are transported between the anode and a cathode during charge and discharge of the electrochemical cell).

In certain embodiments, the anode comprises one or more additives or dopants disposed (e.g., coated as a film) on a top surface of the metal, metallic alloy, or metallic compound [e.g., disposed between the surface layer and the metal, metallic alloy, or metal compound or wherein the surface layer is disposed between the one or more additives or dopants (e.g., coated as a film) and the metal, metallic alloy, or metallic compound] (e.g., wherein the one or more additives or dopants are electrically conductive). In certain embodiments, the one or more additives or dopants are disposed (e.g., coated) as a film and the film is permeable to one or more monovalent or multivalent ions selected from the group consisting of lithium, sodium, potassium, cerium, calcium, cerium, magnesium, manganese, aluminum, zinc, copper, titanium, chromium, cobalt, rubidium, iron, molybdenum, nickel, vanadium, silicon, manganese, magnesium, zirconium, ruthenium, rubidium, indium, gallium, silver, and tin.

In certain embodiments, the anode comprises one or more additive or dopants that are dispersed within the surface layer (e.g., wherein the one or more additives or dopants are electrically conductive).

In certain embodiments, the one or more additives or dopants are selected from the group consisting of carbon, tungsten, tungsten carbide, bismuth, bismuth oxide, silicon, silicon oxide, aluminum, aluminum oxide, gallium, indium, indium tin oxide, tin, iodine, nitrogen, sulfur, nitrides, nitrates, nitrites, sulfides, sulfates, sulfites, phosphorus, phosphides, phosphates, carbides, silver, gold, platinum, and combinations thereof.

In certain embodiments, the metal, metallic alloy, or metallic compound (e.g., and/or current collector) has been treated with a solution (e.g., an electrolyte) comprising ions selected from the group consisting of ions derived from bismuth, indium, gallium, tin, zinc, nitrates, sulfates, acetates, halides, sulfonimides, triflates, tris(trimethylsilyl) borate, citric acid, oxalic acid, tartaric acid, salicylic acid, acetic acid, adipic acid, sebacic acid, boric acid, nitric acid, phosphoric acid, sulfuric acid, hydrochloric acid, and combinations thereof.

In certain embodiments, the metal, metallic alloy, or metallic compound (e.g., and/or current collector) has been treated with a solution (e.g., an electrolyte) comprising one or more components selected from the group consisting of lithium bis(trifluoromethanesulfonyl)imide, lithium bis(fluorosulfonyl)imide, potassium bis(trifluoromethanesulfonyl)imide, potassium bis(fluorosulfonyl)imide, sodium bis(trifluoromethanesulfonyl)imide, sodium bis(fluorosulfonyl)imide, aluminum bis(trifluoromethanesulfonyl)imide, aluminum bis(fluorosulfonyl)imide, manganese bis(trifluoromethanesulfonyl)imide, manganese bis(fluorosulfonyl)imide, lithium difluoro(oxalato)borate, lithium tetrafluoroborate, calcium tetrafluoroborate, potassium tetrafluoroborate, sodium tetrafluoroborate, lithium bis(trifluoromethanesulfonate), potassium bis(trifluoromethanesulfonate), calcium bis(trifluoromethanesulfonate), sodium bis(trifluoromethanesulfonate), aluminum bis(trifluoromethanesulfonate), manganese bis(trifluoromethanesulfonate), 1,1,2,2-tetrafluoroethyl-2′,2′,2′-trifluoroethyl ether, boric acid, ammonium tetrafluoroborate, sodium tetrafluoroborate, calcium tetrafluoroborate, potassium tetrafluoroborate, lithium tetrafluoroborate, pyrrole, aniline, vanillin, and thiophene.

In certain embodiments, the anode is comprised in the electrochemical cell and the treating has occurred prior to incorporation of the anode into the electrochemical cell.

In certain embodiments, the anode comprises a hydrophobic surface (e.g., wherein the hydrophobic surface is inherent or has been obtained through a surface treatment) (e.g., wherein the hydrophobic surface is a surface of the surface layer or another surface of the anode).

In certain embodiments, the anode comprises a hydrophilic surface (e.g., wherein the hydrophilic surface is inherent or has been obtained through a surface treatment) (e.g., wherein the hydrophilic surface is a surface of the surface layer or another surface of the anode).

In another aspect, the disclosure is directed to an electrochemical cell, comprising: at least two electrodes (e.g., an anode and a cathode) (e.g., wherein one or more of the at least two electrodes is an electrode as disclosed herein); an (e.g., liquid, e.g., aqueous) electrolyte comprising a solvent and a salt; and a surface layer disposed on or in (e.g., comprised in) at least one of the at least two electrodes between the at least two electrodes [e.g., in direct contact with the electrolyte or between a layer (e.g., a conductive layer) and an electrode].

In certain embodiments, the surface layer is a cathode comprised in the at least two electrodes. In certain embodiments, comprising a second cathode (e.g., a manganese oxide cathode as disclosed herein or a vanadium oxide cathode as disclosed herein).

In certain embodiments, the at least two electrodes comprises an electrode (e.g., an anode or a cathode) comprising a material structured to convert (e.g., reversibly, e.g., during electrochemical cycling) to a second material by undergoing full or partial reduction or oxidation. In certain embodiments, the material is structured to further convert (e.g., reversibly, e.g., during electrochemical cycling) from the second material to a third material upon further reduction or oxidation. In certain embodiments, the material is selected from the group consisting of metals, oxides, hydroxides, oxide hydroxides, oxychlorides, oxynitrate, carbonates, phosphates, nitrates, nitrites, sulfates, sulfites, triflates, sulfonimides, oxalatoborates, acetates, nitrides, carbides, polymers, and combinations thereof. In certain embodiments, the material comprises one or more monovalent elements and/or one or more multivalent elements selected from the group consisting of hydrogen, lithium, carbon, nitrogen, oxygen, sodium, magnesium, aluminum, silicon, potassium, calcium, titanium, vanadium, chromium, manganese, iron, cobalt, nickel, copper, zinc, gallium, zirconium, niobium, molybdenum, ruthenium, indium, tin, tungsten, lead, bismuth, and combinations thereof.

In certain embodiments, the electrochemical cell is operable to store charge based, at least in part, on ionic contribution from the electrolyte, wherein ions are contributed from an anode, a cathode, or an existing composition of the electrolyte.

In certain embodiments, the electrochemical cell comprises a (e.g., liquid, e.g., aqueous) second electrolyte comprising a solvent and a salt. In certain embodiments, the electrolyte is in direct contact with one of the at least two electrodes (e.g., an anode) and the second electrolyte is in direct contact with another of the at least two electrodes (e.g., a cathode).

In certain embodiments, the electrolyte and the second electrolyte are miscible.

In certain embodiments, the electrolyte and the second electrolyte are immiscible.

In certain embodiments, the electrolyte and the second electrolyte are separated by a separator.

In certain embodiments, the surface layer is a separator.

In certain embodiments, the surface layer is a charge storage layer.

In certain embodiments, the surface layer is a passivation layer.

In certain embodiments, the electrochemical cell further comprises a second surface layer. In certain embodiments, the second surface layer is disposed on (e.g., and in direct contact with) the surface layer (e.g., wherein one of the second surface layer and the surface layer is in direct contact with the electrolyte). In certain embodiments, the electrochemical cell comprises an intermediate layer (e.g., a conductive layer, such as a carbon layer from a carbonization) disposed between the surface layer and the second surface layer.

In certain embodiments, the surface layer is a solid surface layer and the second surface layer is a semi-solid (e.g., gel or gelatinous) layer.

In certain embodiments, the surface layer and the second surface layer are semi-solid (e.g., gel or gelatinous) layers.

In certain embodiments, the surface layer has been formed by a formation process and the second surface layer has been formed by electrochemical cycling.

In certain embodiments, one of the surface layer and the second surface layer is a passivation layer and the other of the surface layer and the second surface layer is an electrochemically active layer (e.g., a charge storage layer).

In certain embodiments, one or both of the surface layer and the second surface layer is a separator.

In certain embodiments, the surface layer is contiguous or discontiguous (e.g., comprises isolated portions).

In another aspect, the disclosure is directed to a method of forming an electrochemical cell, the method comprising: providing an electrode (e.g., an anode or a cathode); carbon coating the electrode (e.g., by a carbonization process); assembling the electrode into an electrochemical cell; and cycling the electrochemical cell thereby forming a surface layer comprised in the electrochemical cell.

Any two or more of the features described in this specification, including in this summary section, may be combined to form implementations not specifically explicitly described in this specification. For example, one of ordinary skill in the art will readily appreciate that different electrodes (e.g., anodes, cathodes), surface layers, electrolytes, and separators can be combined in various combinations to form embodiments of the present disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 illustrates an aluminum structure without and with a treated surface layer (e.g., film) either by bottom up (e.g., deposition type) or top down (e.g., existing surface modification) approach, according to illustrative embodiments of the present disclosure;

FIG. 2A illustrates elemental mapping of an example metallic foil with a surface layer grown by electrochemical cycling, according to illustrative embodiments of the present disclosure;

FIG. 2B illustrates formation of an ion storage region in a surface layer (e.g., film) on an electrode (e.g., anode), according to illustrative embodiments of the present disclosure;

FIG. 3 illustrates a formation and decomposition process of bubbles in a semi-solid (e.g., gel or gelatinous) surface layer including, depending on the chemical and electrochemical condition, (i) bubble formation, (ii) bubble growth, (iii) bubble isolation, (iv) bubble shrinkage, and (v) bubble disappearance, according to illustrative embodiments of the present disclosure; and

FIG. 4A-4B illustrate a charge storage mechanism in a surface layer gel driven by a high negative solvation energy through the dipole moment where FIG. 4A specifically shows schematics of the solvation shell and FIG. 4B specifically shows schematics of the solvation in water (e.g., in an aqueous electrolyte) (left) and gel (right), according to illustrative embodiments of the present disclosure.

### DETAILED DESCRIPTION OF CERTAIN EMBODIMENTS

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

Headers are provided for the convenience of the reader and are not intended to be limiting with respect to the claimed subject matter.

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3% 2%, 1%, or less in either direction (greater than or less than) of the stated reference value unless otherwise stated or otherwise evident from the context (except where such number would exceed 100% of a possible value).

An electrochemical cell may be a battery, such as a rechargeable battery. The battery may include two electrodes (e.g., an anode and a cathode), an electrolyte (e.g., solution or solid electrolyte) disposed between the electrodes, and, optionally, a porous separator that prevents contact of the anode and the cathode. An electrode (e.g., anode or cathode) may include a current collector that includes a current collector substrate. In some embodiments, a battery is charged and discharged by physical transport of an ion, such as an ion comprising aluminum (e.g., a polyatomic ion comprising aluminum), between electrodes (e.g., cathode and anode) in the battery. Embodiments of cathodes, anodes (e.g., structures thereof), electrolytes, and separators that can be used in electrochemical cells (e.g., batteries, such as rechargeable batteries) disclosed herein and batteries that can be adapted to use anodes, electrolytes, or current collector substrates disclosed herein are described in U.S. patent application Ser. No. 16/812,261, filed on Mar. 6, 2020 and U.S. patent application Ser. No. 15/730,683, filed on Oct. 11, 2017, each of which is hereby incorporated by reference herein in its entirety.

As one of ordinary skill in the art can appreciate, in some embodiments, an electrode that is an anode for one electrochemical cell can be used as a cathode in another electrochemical cell and, in some embodiments, an electrode that is a cathode for one electrochemical cell can be used as an anode for another electrochemical cell. Throughout this description, where a feature is described as being part of (e.g., used in) an anode, unless otherwise clear from context, it is contemplated that the feature can be used or adapted for use in a cathode and where a feature is described as being part of (e.g., used in) a cathode, unless otherwise clear from context, it is contemplated that the feature can be used or adapted for use in an anode.

### Electrodes

In some embodiments, an electrochemical system includes two electrodes, for example an anode and a cathode. One or both electrodes may include one or more of an alloy or a chemical bonded to one or more of metal, metalloid, metal oxide, metal sulfide, metal nitride, metal carbide, metal halides, transition metal oxide, transition metal halides, or a transition metal sulfide wherein the list of metals and metalloids include lithium, sodium, potassium, calcium, magnesium, strontium, cerium, titanium, vanadium, chromium, manganese, iron, cobalt, nickel, copper, zinc, carbon, aluminum, gallium, bismuth, silicon, sulfur, zirconium, silver, cadmium, indium, tin, and tungsten. Electrodes described herein can be deposited by means of wet chemical reaction, physical vapor deposition, chemical vapor deposition, atomic layer deposition, sintering, pressing, hot pressing, extrusion, die casting, slot-die coating, and doctor-blade coating. A coating layer may be further mixed with polymers to assist in adhesion and cohesion or to enable formation of a polymeric matrix that contains the electrode species. The coating layer may, additionally or alternatively, include conductive additives such as carbon and other metals. One or both the electrodes may be in the form of foils or shims, whether comprising metals, metallic alloys, or metallic compounds.

In some embodiments, one of two electrodes is an oxidized manganese species that has a stoichiometry of MnₓO_{y}, wherein x and y range from 1 and 7, preferably x between 1 and 3 and y between 2 and 4. Thus, an electrode (e.g., a cathode) may include a manganese oxide, e.g., in one or more structures such as films or particles. The manganese oxide may further include monovalent or multivalent cations including but not limited to lithium, potassium, calcium, sodium, cerium, aluminum, indium, gallium, bismuth, copper, zinc, titanium, iron, tin, vanadium, magnesium, cobalt, chromium, nickel, and silver. These may exist in one or more of (i) between the layers of manganese oxide, (ii) at vacancies, (iii) as pillars, (iv) at interstitial voids (e.g., sites, spaces), or (v) at defect sites. The oxidized manganese species may also include anions, including but not limited to one or a combination sulfates, oxides, hydroxides, oxide-hydroxides, phosphates, nitrates, acetates, sulfides, nitride, nitrites, halides, triflates, sulfonimides, oxalatoborates. The oxidized manganese species may further be hydrated.

In some embodiments, one or both electrodes are coated by one or more surface films, that may each individually be continuous (e.g., having variable thickness) or discontinuous. The film may include one or more of an alloy and a chemical bond of one or more of lithium, sodium, potassium, calcium, magnesium, strontium, cerium, titanium, vanadium, chromium, manganese, iron, cobalt, nickel, copper, zinc, carbon, aluminum, silicon, zirconium, silver, cadmium, indium, gallium, bismuth, copper, tin, and tungsten; carbides, sulfates, phosphates, hydroxides, oxides, and oxide-hydroxides of the aforementioned metals. The coating may either serve as a pseudo solid-electrolyte interphase layer that protects the underlying electrode or may serve as an active site to host and release ions or may serve as a medium to conduct ions through the film to the underlying electrode.

Certain electrodes described herein are further capable of reversibly storing and releasing ions, wherein the ions are physically transported between the two electrodes or between one electrode to the electrolyte and subsequently from the electrolyte to the counter electrode.

In some embodiments, one or more of a metallic foil, a cathode, and a current collector substrate is treated in a solution containing ions selected from the group of bismuth, indium, gallium, tin, zinc, nitrates, sulfates, acetates, halides, sulfonimides, triflates, and may also include components from the list of tris(trimethylsilyl) borate, citric acid, oxalic acid, tartaric acid, salicylic acid, acetic acid, adipic acid, sebacic acid, boric acid, nitric acid, phosphoric acid, sulfuric acid, and hydrochloric acid, prior to assembling the electrochemical device.

In some embodiments, one or more of the metallic foil, the cathode, and the current collector substrate is treated in a solution containing one or more components selected from the group consisting of lithium bis(trifluoromethanesulfonyl)imide, lithium bis(fluorosulfonyl)imide, potassium bis(trifluoromethanesulfonyl)imide, potassium bis(fluorosulfonyl)imide, sodium bis(trifluoromethanesulfonyl)imide, sodium bis(fluorosulfonyl)imide, aluminum bis(trifluoromethanesulfonyl)imide, aluminum bis(fluorosulfonyl)imide, manganese bis(trifluoromethanesulfonyl)imide, manganese bis(fluorosulfonyl)imide, lithium difluoro(oxalato)borate, lithium tetrafluoroborate, calcium tetrafluoroborate, potassium tetrafluoroborate, sodium tetrafluoroborate, lithium bis(trifluoromethanesulfonate), potassium bis(trifluoromethanesulfonate), calcium bis(trifluoromethanesulfonate), sodium bis(trifluoromethanesulfonate), aluminum bis(trifluoromethanesulfonate), manganese bis(trifluoromethanesulfonate), 1,1,2,2-tetrafluoroethyl-2′,2′,2′-trifluoroethyl ether, boric acid, ammonium tetrafluoroborate, sodium tetrafluoroborate, calcium tetrafluoroborate, potassium tetrafluoroborate, lithium tetrafluoroborate, pyrrole, aniline, vanillin, and thiophene prior to assembling the electrochemical device.

In some embodiments, one or both electrodes may contain a material capable of converting to a second material by undergoing full or partial reduction or oxidation. In some embodiments, this second material may be capable of undergoing further reduction or oxidation to form a third material. The conversion between the initial material and the second material, the second material and the third material, or the initial material and the third material may be reversible such that conversion between materials occurs during an electrochemical cycling process. Other intermediate materials may also form during conversion between described materials. An initial material may include, but is not limited to, a metal, oxide, hydroxide, oxide hydroxide, oxychloride, oxynitrate, carbonate, phosphate, nitrate, nitrite, sulfate, sulfite, triflate, sulfonimide, oxalatoborate, acetate, nitride, carbide, polymer, or combination thereof and may contain one or more of hydrogen, lithium, carbon, nitrogen, oxygen, sodium, magnesium, aluminum, silicon, potassium, calcium, titanium, vanadium, chromium, manganese, iron, cobalt, nickel, copper, zinc, gallium, zirconium, niobium, molybdenum, ruthenium, indium, tin, tungsten, lead, bismuth, or some combination thereof. The material may be freestanding or may be present on a substrate (e.g., a current collector). The substrate may include, but is not limited to, carbon materials such as foams, papers, aerogels, foils, or nanostructures, or metal foils, foams, sheets, meshes, or stock, as well as other metals such as steel, aluminum, titanium, tin, tin oxide, indium tin oxide, and copper. The substrate may further be coated by a thin film including one or more or a combination of a carbon film, a chromium or chromium oxide film, a molybdenum or molybdenum sulfide film, a tungsten or tungsten sulfide or tungsten carbide film, a silver or silver oxide film, a platinum film, a gold film, a cobalt or cobalt oxide film, a copper or copper oxide film, an aluminum or aluminum oxide or aluminum phosphate film, a vanadium or vanadium oxide film, and a titanium or a titanium oxide film. The term film, used here and elsewhere, refers generally to any coating structure including a thin film, a porous template, fibers, and nanostructures.

In some embodiments, an electrochemical charge storage mechanism of an electrochemical cell involves transfer or redox reactions involving one or more ions between the two electrodes, wherein the one or more ions may include lithium, sodium, potassium, calcium, manganese, aluminum, silicon, cerium, rubidium, nickel, copper, bismuth, indium, gallium, tin, zinc, tungsten, oxides, hydroxides, oxide-hydroxides, aluminates, silicates, nitrates, nitrites, nitrides, sulfates, sulfites, sulfides, carbonates, carbides, halides, triflates, and protons.

### Anodes

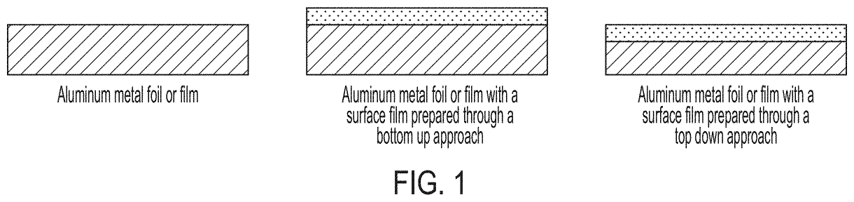

In certain embodiments, an electrochemical cell (e.g., battery) includes an anode comprising an aluminum structure. The aluminum structure may comprise a metal foil or film or film on foil, an aluminum alloy or an anodized aluminum. In some embodiments, aluminum having purity ranging from 50 wt. % to 99.99999 wt. % (7N) is used as or in an anode (e.g., as a foil or film in an anode). The aluminum structure (e.g., having a high purity, e.g., of at least 99.99%) may be treated ex situ, prior to assembly of an electrochemical cell, or in situ, after assembly of an electrochemical cell. A treatment of an aluminum structure may be performed passively (e.g., by submerging the structure in a chemical environment) or actively (e.g., through electrochemical cycling) to create a surface layer. A surface layer formed by treatment of an aluminum structure may result in a surface layer having a cross-sectional thickness in a range of from 0.1 nm to 100 μm. In some embodiments, an aluminum structure is treated such that a surface layer is created into existing aluminum metal, either as a discrete layer or a gradient. The morphology of the surface layer may be that of a dense film or a porous structure, for example as shown in FIG. 1, with a varied degree of order ranging from crystalline to amorphous.

In some embodiments, treatment of an aluminum structure includes chemical treatment involving one or more of a hydroxide, alkoxide, peroxide, superoxide, nitrate, nitrite, sulfate, sulfite, sulfide, carbonate, phosphate, phosphide and halide of one or more monovalent or multivalent atoms that can be or include, but are not limited to, sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, and copper. Treatment may be preceded or succeeded or contemporaneously (e.g., intermittently) involve acid, base, reductive, or oxidative surface treatment. A resulting surface layer of a treated aluminum structure comprises (e.g., at least 50 wt. %, at least 70 wt. %, at least 80 wt. %, at least 90 wt. %, or at least 95 wt. % of) one or more materials each having a stoichiometry of M1¹⁺ₓN1ₚN2_{q} or M1²⁺ₓN1ₚN2_{q} or M1³⁺ₓN1ₚN2_{q} or M1⁴⁺ₓN1ₚN2_{q} or M1¹⁺ₓM2²⁺_{y}N1ₚ or M1¹⁺ₓM2³⁺_{y}N1ₚ or M1¹⁺ₓM2⁴⁺_{y}N1ₚ or M1²⁺ₓM2³⁺_{y}N1ₚ M1²⁺ₓM2⁴⁺_{y}N1ₚ or M1³⁺ₓM2⁴⁺_{y}N1ₚ or M1¹⁺ₓM2²⁺_{y}N1ₚN2_{q} or M1¹⁺ₓM2³⁺_{y}N1ₚN2_{q} or M1¹⁺ₓM2⁴⁺_{y}N1ₚN2_{q} or M1²⁺ₓM2³⁺_{y}N1ₚN2_{q} or M1²⁺ₓM2⁴⁺_{y}N1ₚN2_{q} or M1³⁺ₓM2⁴⁺_{y}N1ₚN2_{q} or M1¹⁺ₓM2²⁺_{y}M3³⁺_{z}N1ₚ or M1¹⁺ₓM2²⁺_{y}M3⁴⁺_{z}N1ₚ or M1²⁺ₓM2³⁺_{y}M3⁴⁺_{z}N1ₚ or M1¹⁺ₓM2²⁺_{y}M3³⁺_{z}N1ₚN2_{q} or M1¹⁺ₓM2²⁺_{y}M3⁴⁺_{z}N1ₚN2_{q} or M1²⁺ₓM2³⁺_{y}M3⁴⁺_{z}N1ₚN2_{q} or M1¹⁺ₓM2²⁺_{y}M3³⁺_{z}M4⁴⁺ₛN1ₚ or M1¹⁺ₓM2²⁺_{y}M3³⁺_{z}M4⁴⁺ₛN1ₚ N2_{q}, wherein each M is a monovalent, bivalent, trivalent or tetravalent atom and each N is a functional group, for example, selected from the group consisting of hydroxide, alkoxide, peroxide, superoxide, nitrate, nitrite, sulfate, sulfite, sulfide, carbonate, phosphate, phosphate, phosphide and halide.

As an example, in some embodiments, an aluminum structure is submerged in a solution comprising 0.1M hydrochloric acid for 30 mins to 60 mins and at room temperature (e.g., 16-24° C.). Subsequently, the aluminum structure is washed to obtain a surface layer comprising a material having a stoichiometry of Alₓ³⁺Clₚ. The structure is then re-submerged in a solution comprising 1M sodium chloride and a negative potential is applied to create a surface layer (e.g., film) on the aluminum structure comprising (e.g., at least 50 wt. %, at least 70 wt. %, at least 80 wt. %, at least 90 wt. %, or at least 95 wt. % of) a material having a stoichiometry of Alₓ³⁺Na_{y}¹⁺Clₚ. This as-obtained structure is washed again and re-submerged in a solution comprising 1M zinc hydroxide. Following this, first a positive potential is applied on the aluminum structure to create a surface layer comprising (e.g., at least 50 wt. %, at least 70 wt. %, at least 80 wt. %, at least 90 wt. %, or at least 95 wt. % of) a material having a stoichiometry of Alₓ³⁺Na_{y}¹⁺ClₚOH_{q}, followed by a negative potential such that the surface layer comprises (e.g., at least 50 wt. %, at least 70 wt. %, at least 80 wt. %, at least 90 wt. %, or at least 95 wt. % of) a material having a stoichiometry of Alₓ³⁺Na_{y}¹⁺Zn_{z}²⁺ClₚOH_{q}. The chloride and hydroxide used may be in their neutral state or partially or fully charged states.

In some embodiments, a surface layer may comprise (e.g., at least 50 wt. %, at least 70 wt. %, at least 80 wt. %, at least 90 wt. %, or at least 95 wt. % of) a material that further includes one or more positively charged metallic or non-metallic elements with one or more negatively charged halides or functional groups to create one or more complexity.

In some embodiments, a surface layer comprises (e.g., at least 50 wt. %, at least 70 wt. %, at least 80 wt. %, at least 90 wt. %, or at least 95 wt. % of) one or more materials each having a stoichiometry of M1¹⁺ₓN1ₚ or M1²⁺ₓN1ₚ or M1³⁺ₓN1ₚ or M1⁴⁺ₓN1ₚ wherein M is a monovalent or multivalent atom and N is a functional group selected from alkoxide, peroxide, superoxide, nitrate, nitrite, sulfate, sulfite, sulfide, carbonate, phosphate, phosphate, phosphide and halide.

In some embodiments, a surface layer comprises (e.g., at least 50 wt. %, at least 70 wt. %, at least 80 wt. %, at least 90 wt. %, or at least 95 wt. % of) one or more materials each having a stoichiometry of M1ₓN1ₚN2_{q} or M1ₓM2_{y}N1ₚ or M1ₓM2_{y}N1ₚN2_{q} or M1ₓM2_{y}M3_{z}N1ₚ or M1ₓM2_{y}M3_{z}N1ₚN2_{q} or M1ₓM2_{y}M3_{z}M4ₛN1ₚ or M1ₓM2_{y}M3_{z}M4ₛN1ₚN2_{q}, wherein each M may comprise a monovalent or multivalent atom selected from the group consisting of rare earth metals, transition metals, alkali metals, alkaline earth metals, and main-group elements. In some embodiments, each M may independently exist in one or more (e.g., different) oxidation states and/or may otherwise undergo transition from one oxidation state to another during storage, no load condition(s) or electrochemical cycling.

In some embodiments, a surface layer may comprise a material comprising atoms and functional groups with the general notation M1ₓM2_{y}M3_{z} . . . N1ₚN2_{q}N3ᵣ . . . and so on to create one or more components of one or more complexity.

A surface layer of an aluminum structure of an anode may further include water molecules, such as water molecules disposed in a crystal structure (e.g., water of hydration).

In some embodiments, an aluminum structure having a surface layer acts as a either a solid electrolyte interface or a pseudo-solid electrolyte interface in an electrochemical cell (e.g., battery)

In some embodiments, an aluminum structure having a surface layer acts as an insulating ionic diffusion barrier in an electrochemical cell (e.g., battery) to prevent the flow of charge carriers from bulk of a solid (e.g., underlying portion of an aluminum structure) into an electrolyte.

In some embodiments, an aluminum structure having a surface layer acts as an active electrode layer in an electrochemical cell, wherein active (e.g., charge carrying) ions in the electrochemical cell include one or more of ions of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, and copper, which are are released and stored from the surface layer during cycling of the electrochemical cell. In some embodiments, release and storage of active ions may be further coupled by release of cations from the underlying portion of the aluminum structure.

In one example, an electrochemical cell comprising an anode comprising an aluminum structure comprising a surface layer having a stoichiometry of M1¹⁺ₓM2²⁺_{y}M3³⁺_{z}N1ₚN2_{q} (wherein each N is a functional group and each M is an atom of the written valence) had a measured capacity greater than 200 mAh/g at a charge-discharge rate ranging between C/8 and C/12. Subsequently, the stability of these structures results in significantly superior cycling ability in a wide variety of electrochemical environments, exceeding thousands of cycles of safe charge and discharge. This also includes operational environments such as deep discharge and over-charge, indicating a surface layer's ability to prevent long-term metal degradation, plating, or dendrite formation.

An active electrode (e.g., anode) may comprise a metal (e.g., metallic foil), metallic alloy, or metallic compound comprising one or more monovalent or multivalent elements including but not limited to lithium, sodium, potassium, calcium, cerium, aluminum, zinc, copper, titanium, chromium, cobalt, rubidium, iron, molybdenum, tungsten, carbon, nickel, vanadium, silicon, manganese, magnesium, silicon, calcium, zirconium, ruthenium, indium, tin, gallium, bismuth, silver, gold, and platinum. The metal, metallic alloy, or metallic compound may further be in the form of metal phosphates, metal sulfates, metal nitrides, metal nitrates, metal oxides, metal hydroxides, metal oxide hydroxide, aluminates, silicates, metal carbides, and combination thereof, either by themselves or in addition to pure metallic forms.

In some embodiments, an active electrode comprises metal, metallic alloys, or metallic compounds (e.g., composites) of one or more monovalent or multivalent elements including but not limited to lithium, sodium, potassium, calcium, cerium, aluminum, zinc, copper, titanium, chromium, cobalt, rubidium, iron, molybdenum, tungsten, carbon, nickel, vanadium, silicon, manganese, magnesium, silicon, calcium, zirconium, ruthenium, indium, tin, gallium, bismuth, silver, gold, and platinum, that is coated on to a current collector substrate. The coating may be carried out by vapor deposition processes, including physical vapor deposition, chemical vapor deposition, or atomic layer deposition, or through wet coating process including in situ (such as a layer built during a formation step or electrochemical cycling) or ex situ chemical reactions, draw-down, doctor-blade, slot-die, comma-coating, or reverse comma-coating. The active electrode may further be in the form metal phosphates, metal sulfates, metal nitrides, metal nitrates, metal oxides, metal hydroxides, metal oxide hydroxide, aluminates, silicates, metal carbides, and combination thereof, either by themselves or in addition to pure metallic forms. The active electrode may further include polymer binders and conductive carbons that may be deemed necessary to achieve good distribution, conductivity, adhesion, and cohesion, among other coating properties.

In some embodiments, a metal foil is used as an electrode in a battery, wherein active ions transported between the electrode and the counter-electrode include one or more of the following monovalent or multivalent ions including, but not limited to, lithium, sodium, potassium, calcium, tungsten, cerium, aluminum, zinc, copper, iron, vanadium, silicon, manganese, magnesium, titanium, cobalt, chromium, nickel, and calcium.

In some embodiments, there is a surface layer formed on the metal, metallic alloy, or metallic compound during a pre-treatment process, a formation process in an electrochemical cell, or during cycling of an electrochemical cell. Such a surface layer may be formed bottom up, that is, extending from the surface of the metallic foil, or top down, that is, growing into the metallic foil. Such a surface layer includes one or both of an ordered layered structure or a disordered structure, wherein constituents of the surface layer comprise one or more of the following monovalent or multivalent elements including but not limited to, lithium, sodium, potassium, calcium, cerium, boron, tungsten, aluminum, zinc, copper, titanium, chromium, cobalt, iron, molybdenum, nickel, vanadium, silicon, manganese, magnesium, silicon, calcium, zirconium, ruthenium, indium, tin, silver, gold, and platinum. Additionally or alternatively, a surface layer may include one or more anions or molecules including hydroxide, oxide, oxide hydroxide, nitrate, sulfate, carbide, phosphate, sulfide, triflates, sulfonimides, oxalatoborates, acetates, nitride, or a combination. A surface layer may, alternatively or additionally, include one or more of silicon, silicon monoxide, silicon dioxide, and water crystals. A surface layer may include a multivalent element from the lists above and a monovalent element including lithium, sodium, potassium, or cesium.

In some embodiments, one or more additive or dopant including but not limited to carbon, tungsten, tungsten carbide, bismuth, bismuth oxide, silicon, silicon oxide, aluminum, aluminum oxide, gallium, indium, indium tin oxide, tin, iodine, nitrogen, nitrides, nitrates, sulfur, sulfides, sulfates, phosphorus, phosphides, phosphates, carbides, silver, gold, and platinum and combinations thereof is coated as a film on top of a metal, metallic alloy, or metallic compound wherein the surface layer is formed either on top of this film or is grown at the interface of the metallic foil and the film. In some embodiments, one or more conductive additives are dispersed in a surface layer. In some embodiments, an additive is coated as a film on top of a metallic foil, the film is permeable to monovalent and multivalent ions including, but not limited to, lithium, sodium, potassium, cerium, calcium, magnesium, manganese, aluminum, zinc, copper, titanium, chromium, cobalt, rubidium, iron, molybdenum, nickel, vanadium, silicon, manganese, magnesium, zirconium, ruthenium, indium, gallium, silver, and tin. In some embodiments, a film or films may serve as a conductive additive.

In some embodiments, anodes comprising a metallic foil, conductive additive, and a surface layer, allow for storage and release of active ions participating in an electrochemical cell. Electroactive ions may contributed by one or more of a metal, alloy, or compound foil, a surface layer, a conductive additive, and ions present as salt(s) in an electrolyte. These active ions may include but are not limited to lithium, sodium, potassium, cerium, calcium, magnesium, manganese, aluminum, zinc, copper, titanium, chromium, cobalt, rubidium, iron, molybdenum, nickel, vanadium, silicon, manganese, magnesium, zirconium, ruthenium, indium, silver, and tin. These active ions may also exist and be transported in the form of ionic complexes including one or more of the cations listed above and anions selected from the group comprising nitrate, sulfate, phosphate, oxide, hydroxide, oxide-hydroxide, triflates, sulfonimides, oxalatoborates, acetates, halides, or a combination.

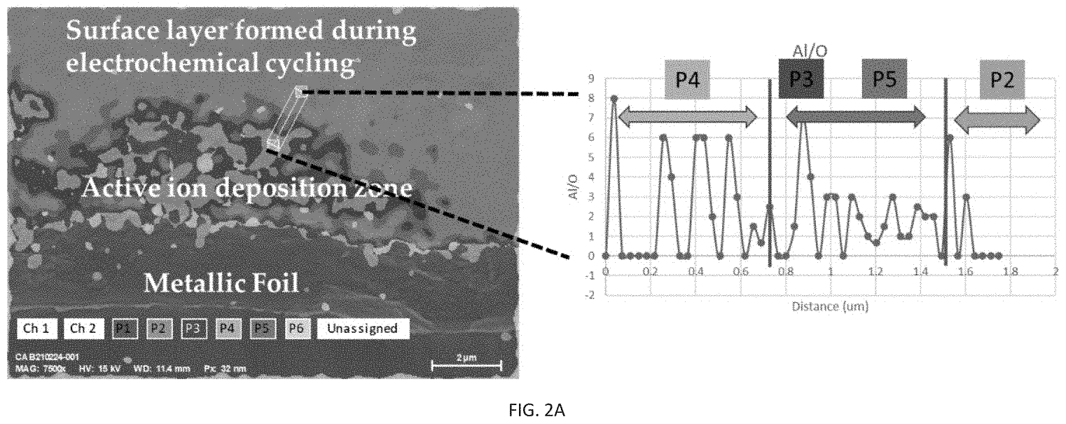

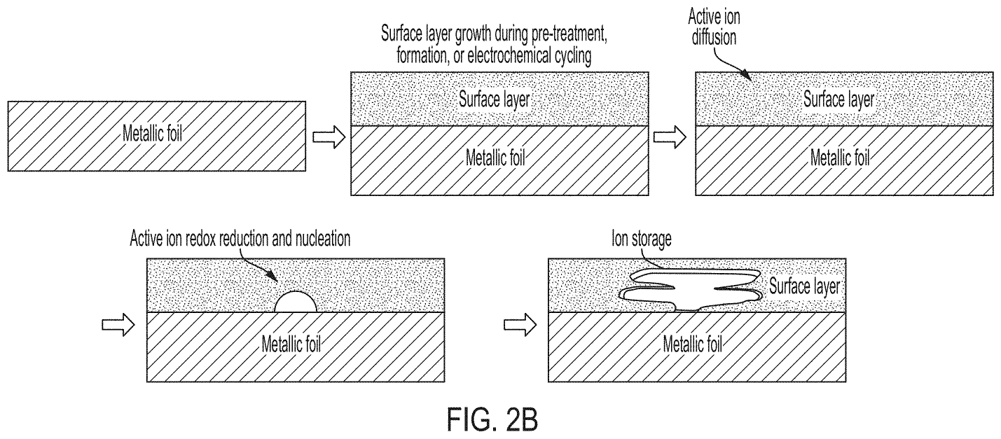

In a working example, a metallic foil comprising of aluminum was cycled in an electrochemical cell using an aqueous electrolyte and an elemental mapping was carried out to measure the ratio of aluminum and oxygen in the surface layer. Elemental mapping of the cross-section showed a significant concentration of aluminum at the interface of the metallic foil and the surface layer. Line scan of the surface layer, as shown in FIGS. 2A-2B, also shows a very high concentration of aluminum, relative to oxygen, that generally reduces as the distance from the interface increases, indicating ionic diffusion through this surface layer. The aluminum to oxygen ratio in this particular line scan is as high as 1:8, while it can be considerably higher closer to the metallic foil and surface layer interface. This post cycling imaging and elemental mapping confirms that the surface layer is acting as an active site to host and release anions and cations involved in the electrochemical reaction.

In some embodiments, a surface layer formed on top of a metallic foil, with or without the additive, serves as a solid or semi-solid (e.g., gel or gelatinous) electrolyte interphase passivating layer that is permeable to ions including but not limited to lithium, sodium, potassium, cerium, calcium, magnesium, manganese, aluminum, zinc, copper, titanium, chromium, cobalt, rubidium, iron, molybdenum, nickel, vanadium, silicon, manganese, magnesium, zirconium, ruthenium, indium, silver, tin, nitrate, sulfate, phosphate, oxide, hydroxide, oxide-hydroxide, and combinations thereof.

In some embodiments, active ions described above may be replaced by protons from the electrolyte during charge and/or discharge. While not wishing to be bound by theory, a possible reaction mechanism may be described as:

—O-M(OH₂)_{x-1 (s)}+H⁺+H₂O→—O^{δ}---H⁺+M(OH₂)ₓ⁺_{(aq)}+e⁻, where M is a metal selected from above.

In another reaction mechanism, the active ions described above may be electroplated and stripped at the anode during charge and discharge. While not wishing to be bound by theory, a possible reaction mechanism may be described as:

Mⁿ⁺+ne⁻→M⁰, where M is a metal selected from above.

In certain embodiments, an aqueous electrolyte comprises one or more non-aluminum members selected from the group consisting of sodium, lithium, calcium, potassium, magnesium, cerium, boron, bismuth, indium, gallium, manganese, or zinc.

Vanadium oxide is a particularly useful electroactive anode material. An anode may comprise one or more vanadium oxide structures (e.g., particles, films) with a formula VₓO_{y}, wherein x ranges between 1 and 2 and y ranges between 2 and 5 for the stable compound and between 1 and 4 for x and 1 and 9 for y for anionic and/or cationic forms (for example, VO₂⁻¹, V₃O₄⁺¹). Vanadium oxide may have a crystal structure that is one or a combination of monoclinic, rutile, orthorhombic, and trigonal. A vanadium oxide structure may further have one or more of vacancies, defects, and interstitial voids (e.g., sites, spaces). The vanadium oxide may further include one or more electrochemically active ions, comprising magnesium, calcium, aluminum, sodium, potassium, lithium, zinc, iron, tin, titanium, tungsten, copper, rubidium, cerium, and nickel. The electrochemically active ions may exist in the metallic form (such as Mg, Ca, Al, Na, K, Li, Zn, Fe, Sn, Ti, Ni) or as a complex of the metals (such as Mg(OH)₂, Ca(NO₃)₂, and so on). The electrochemically active ions may also exist in a partially charged state (such as Al(OH)₄⁻¹).

In some embodiments, the vanadium oxide structure exists as an alloy or as a mixture in one or more of the following combinations, a transition metal oxide, a transition metal sulfide, a metal oxide, a metal sulfide, or a metal, wherein the metal may include lithium, potassium, calcium, sodium, aluminum, zinc, titanium, iron, tin, vanadium, magnesium, cobalt, chromium, nickel, platinum, gold, and silver.

In some embodiments the vanadium oxide a conductive (e.g., metallic) film may be coated directly on to the vanadium oxide structure, for example formed by a carbonization process. A carbonization process may result in one or more vanadium oxide structures coated with carbon [e.g., coated with a film comprising (e.g., of) carbon] or carbon interspersed within the structure(s) or both. In some embodiments, a vanadium oxide structure may undergo a carbonization process wherein vanadium oxide structure(s) are coated with carbon or have carbon interspersed within each manganese oxide particle. This process may involve the incorporation of a conductive carbon additive to the particle including, but not limited to, carbon black, carbon nanotubes, graphene sheets, acetylene black, carbon fiber, or some combination thereof. This additive may be either hydrophilic or hydrophobic. This process may also involve the incorporation of a carbon precursor into the active particle either before, during, or after particle synthesis followed by subsequent carbonization of that precursor. This precursor can include, but is not limited to, a monosaccharide, a disaccharide, an oligosaccharide, a polysaccharide, an organic acid, a polymer, a polyether, an aromatic carbon, or a combination thereof. The carbonization process may involve techniques including, but not limited to, hydrothermal reaction, physical mixing, wet chemistry, electrochemical coating, spray pyrolysis, and spray drying. In some embodiments, the manganese oxide structure maybe coated by a film of carbon, wherein the carbon film may be hydrophilic or hydrophobic and the coating process may be one or more of physical vapor deposition, chemical vapor deposition, in situ or ex situ chemical reactions, draw-down coating, doctor-blade coating, slot-die coating, comma-coating, or reverse comma-coating. In some embodiments, the manganese oxide structure maybe coated by a film of manganese, manganese oxide, manganese nitrate, manganese sulfate, manganese phosphate, manganese hydroxide, or combinations thereof, wherein the film may be hydrophilic or hydrophobic and the coating process may be one or more of physical vapor deposition, chemical vapor deposition, in situ or ex situ chemical reactions, draw-down coating, doctor-blade coating, slot-die coating, comma-coating, or reverse comma-coating.

In some embodiments, there is a surface layer formed on vanadium oxide structure during a pre-treatment process, a formation process in an electrochemical cell, or during cycling of an electrochemical cell. The formation process may include environment-controlled ageing of vanadium oxide structure(s) in an electrochemical cell (e.g., wherein the structure(s) are in contact with an electrolyte at room temperature or at an elevated temperature) and/or an electrochemical cycling process (e.g., at elevated temperature and/or elevated pressure (e.g., using cycling conditions, such as voltage, separate from normal electrochemical cycling (e.g., as during charge and discharge) of the electrochemical cycling). This surface layer may be formed bottom up, that is, extending from the surface of the metallic foil, or top down, that is, growing into the metallic foil. This surface layer may include one or both of an ordered layered structure or a disordered structure, wherein the constituents of the surface layer comprise one or two of the following multivalent elements including aluminum, zinc, copper, titanium, chromium, cobalt, rubidium, iron, molybdenum, nickel, vanadium, manganese, magnesium, silicon, calcium, zirconium, ruthenium, indium, tin, silver, gold, and platinum. In some embodiments, a surface layer may include one or more anions or molecules including hydroxide, oxide, oxide hydroxide, triflates, sulfonimides, oxalatoborates, acetates, nitrate, sulfate, phosphate, sulfide, nitride, or a combination, or a decomposition product of one or more of these. The surface layer may further include one or more of silicon, silicon monoxide, silicon dioxide, and water crystals.

Vanadium oxide may facilitate charge storage wherein the structure is capable to reversibly contribute to uptake and release of electrochemically active monovalent and multivalent ions including but not limited to lithium, sodium, potassium, calcium, cerium, aluminum, zinc, copper, titanium, chromium, cobalt, rubidium, iron, molybdenum, nickel, vanadium, silicon, manganese, magnesium, silicon, calcium, zirconium, ruthenium, indium, tin, and silver. The reversible uptake and release may occur at storage sites that exist in vacancies within the vanadium oxide structure or at defect sites or in the form of an ion exchange reaction wherein one or more of the cations and anions comprising of the baseline vanadium oxide structure, as described above, are replaced by the electrochemically active monovalent and multivalent ions.

In an extension of the above reaction mechanism, reversible uptake and release of electrochemically active monovalent and multivalent ions may also be facilitated by vanadium within vanadium oxide undergoing a transition of oxidation states. While not wishing to be bound by theory, an example of such an electrochemical reaction would include:

V₂^{[+5]}O₅+M⁺²+2e⁻→V₂^{[+4]}M^{[+2]}O₅, wherein M is a metal ion that can be monovalent or multivalent (as in this example).

Some embodiments describes a reversible uptake and release of electrochemically active monovalent and multivalent ions enabled by vanadium dissolution from the baseline vanadium oxide structure.

In some embodiments, a vanadium oxide structure can undergo a structural modification or material property changes through a pre-treatment process, a formation process, or during electrochemical cycling, that would then act as the active electrode material for reversible uptake and release of electrochemically active monovalent and multivalent ions. The general repeating unit of such stoichiometries could include MₓV_{y}O_{z}, V_{y}O_{z}Aₙ, and MₓV_{y}O_{z}Aₙ, wherein M is a cation and A is an anion, while the structure itself can have one or more cations and anions of different kinds characterized by, as an example, M1ₓ₁M2ₓ₂V_{y}O_{z}, V_{y}O_{z}A1ₙ₁A2ₙ₂, M1ₓ₁M2ₓ₂V_{y}O_{z}A1ₙ₁A2ₙ₂, and so on.

In some embodiments, a vanadium oxide structure releases vanadium ions into the electrolyte which then form a solid electrolyte surface layer (e.g., interphase) or a gel surface layer (e.g., interphase) along with one or more of anions and cations including oxides, oxide-hydroxides, hydroxides, sulfates, sulfides, nitrates, nitrides, phosphates, halides, triflates, sulfonimides, oxalatoborates, acetates, and decomposition products of the former and magnesium, calcium, cerium, aluminum, sodium, potassium, lithium, zinc, iron, tin, manganese, magnesium, silicon, titanium, silver, gold, and nickel, respectively. This solid surface layer (e.g., interphase) or gel surface layer (e.g., interphase) may serve as an ion permeable passivating layer, impeding side reactions, or it may serve as a host to reversibly storage and release electrochemically active ions.

### Cathodes

In some embodiments, an electrochemical cell includes a cathode. In some embodiments, a cathode comprises a transition metal oxide, wherein the metal may include one or a combination of titanium, vanadium, chromium, manganese, iron, cobalt, nickel, copper, zinc, zirconium, molybdenum, and ruthenium. The transition metal oxide may further comprise additives or dopants wherein these may include one or more of sodium, lithium, potassium, calcium, aluminum, rubidium, cerium, strontium, silicon, gallium, indium, tin, bismuth, titanium, vanadium, chromium, manganese, iron, cobalt, nickel, copper, zinc, zirconium, molybdenum, and ruthenium, carbon, phosphorus, nitrogen, iodine, and boron. The process of incorporating additives may include wet chemistry, involving precursors comprising of the additive metals (such as aluminum chloride for aluminum additives or silane for silicon additives), and other techniques such as physical vapor deposition, chemical vapor deposition, spray drying, hydrothermal reaction, and mixing.

An electrode suitable for use as a cathode in an electrochemical cell described herein may include manganese oxide (e.g., in one or more manganese oxide structures, such as particles, such as powdered particles, ordered and disordered structures, spheres, sheets, fibers, or pillars, or films) with a stoichiometry defined as MnₓO_{y}, wherein x and y range from 1 and 7, preferably x between 1 and 3 and y between 2 and 4. The manganese oxide structure may be crystalline or amorphous. The electrode may include a single or multiple crystalline or amorphous phases of the manganese oxide. The manganese oxide structure may further include monovalent or multivalent cations including but not limited to lithium, potassium, calcium, sodium, aluminum, gallium, indium, bismuth, zinc, copper, cerium, lanthanum, rubidium, titanium, iron, tin, lead, vanadium, magnesium, cobalt, chromium, nickel, and silver. These may exist in one or more of (i) between the layers of manganese oxide, (ii) at vacancies, (iii) as pillars, (iv) at interstitial voids (e.g., sites, spaces), or (v) at defect sites. In some embodiments, the manganese oxide structure may also include anions, including but not limited to one or a combination sulfate, oxides, hydroxide, oxide-hydroxide, triflates, sulfonimides, oxalatoborates, acetates, phosphate, nitrate, sulfide, nitride, nitrite, and halides. The manganese oxide structure may further be hydrated (e.g., to influence crystal spacing, such as between sheets).

In some embodiments, a manganese oxide structure may undergo a carbonization process wherein the structure (e.g., manganese oxide particles) is coated with carbon or have carbon interspersed within each manganese oxide particle. This process may involve the incorporation of a conductive carbon additive to the particle including, but not limited to, carbon black, carbon nanotubes, graphene sheets, acetylene black, carbon fiber, or some combination thereof. This additive may be either hydrophilic or hydrophobic. This process may also involve the incorporation of a carbon precursor into the active particle either before, during, or after particle synthesis followed by subsequent carbonization of that precursor. This precursor can include, but is not limited to, a monosaccharide, a disaccharide, an oligosaccharide, a polysaccharide, an organic acid, a polymer, a polyether, an aromatic carbon, or a combination thereof. The carbonization process may involve techniques including, but not limited to, hydrothermal reaction, physical mixing, wet chemistry, electrochemical coating, spray pyrolysis, and spray drying. In some embodiments, the manganese oxide structure maybe coated by a film of carbon, wherein the carbon film may be hydrophilic or hydrophobic and the coating process may be one or more of physical vapor deposition, chemical vapor deposition, in situ or ex situ chemical reactions, draw-down coating, doctor-blade coating, slot-die coating, comma-coating, or reverse comma-coating. In some embodiments, the manganese oxide structure maybe coated by a film of manganese, manganese oxide, manganese nitrate, manganese sulfate, manganese phosphate, manganese hydroxide, or combinations thereof, wherein the film may be hydrophilic or hydrophobic and the coating process may be one or more of physical vapor deposition, chemical vapor deposition, in situ or ex situ chemical reactions, draw-down coating, doctor-blade coating, slot-die coating, comma-coating, or reverse comma-coating.

In some embodiments, the manganese oxide structure may be present as a composite with another compound, or multiple other compounds. These compounds may be selected from metals, nitrates, nitrites, nitrides, sulfates, sulfites, sulfides, carbonates, carbides, phosphates, phosphites, acetates, oxides, hydroxides, oxalates, or halides of lithium, potassium, calcium, sodium, aluminum, gallium, indium, bismuth, zinc, copper, cerium, rubidium, lanthanum, titanium, rubidium, iron, tin, lead, vanadium, magnesium, cobalt, chromium, nickel, and silver. These other compounds may be present, for example, in the range of 0.01% to 50% of the total amount. This composite may be formed during the chemical, electrochemical, or mechanical synthesis of primary particles, or the chemical, electrochemical, or mechanical synthesis of secondary particles including the primary particles.

In some embodiments, the manganese oxide may include an exfoliated structure, a delaminated structure, a sheet-like structure, a tunnel configuration, a spinel structure, or a combination thereof.

In some embodiments, manganese oxide may be coated, either in situ or ex situ with polymers including but not limited to aniline, polyaniline, polypyrrole, and polythiophene.

In some embodiments, manganese oxide may include an additive, either within the cathode or in the electrolyte, to stabilize the mechanical structure, crystal structure, phase, form, morphology, the shape or such other properties that establish the performance of the electrochemical system.

In some embodiments, a manganese oxide structure is able to reversibly contribute to uptake and release of electrochemically active one or more of monovalent and multivalent ions including but not limited to lithium, sodium, potassium, cerium, calcium, aluminum, zinc, copper, titanium, chromium, cobalt, rubidium, iron, molybdenum, nickel, vanadium, silicon, manganese, magnesium, silicon, calcium, zirconium, ruthenium, indium, tin, and silver. In addition to the aforementioned ions, other active species for reversible storage may include one, more, or a combination of water, oxide, hydroxide, sulfate, nitrate, phosphate, halides, or protons. All active species may exist in any of a variety of positions in a manganese oxide lattice including but not limited to single, double, or triple corner sharing sites; single, double, or triple edge sharing sites; inclusions in the lattice by filling vacancy sites, at defect sites or in the form of an ion exchange reaction wherein one or more of the cations and anions comprising baseline manganese oxide structure, as described above, are replaced by the electrochemically active monovalent and multivalent ions.

In an extension of the above reaction mechanism, reversible uptake and release of electrochemically active monovalent and multivalent ions may also be facilitated by manganese within manganese oxide undergoing a transition of oxidation states. While not wishing to be bound by theory, an example of such an electrochemical reaction would include:

Mn^{[+4]}O₂+M⁺¹+e⁻→Mn^{[+3]}M^{[+1]}O₂, wherein M is a metal ion that can be monovalent (as in this example) or multivalent.

Some embodiments describes a reversible uptake and release of electrochemically active monovalent and multivalent ions enabled by manganese dissolution from the baseline manganese oxide structure. In some embodiments, a manganese oxide structure can undergo a structural modification or material property changes through a pre-treatment process, a formation process, or during electrochemical cycling, that would then act as the active electrode material for reversible uptake and release of electrochemically active monovalent and multivalent ions. The general repeating unit of such stoichiometries could include MₓMn_{y}O_{z}, Mn_{y}O_{z}Aₙ, and MₓMn_{y}O_{z}Aₙ, wherein M is a cation and A is an anion, while the structure itself can have one or more cations and anions of different kinds characterized by, as an example, M1ₓ₁M2ₓ₂Mn_{y}O_{z}, Mn_{y}O_{z}A1ₙ₁A2ₙ₂, M1ₓ₁M2ₓ₂Mn_{y}O_{z}A1ₙ₁A2ₙ₂, and so on. The modifications may include insertion of anions or cations in interstitial voids (e.g., sites, spaces), vacancies, and defects within the manganese oxide structure. The modifications may further entail changes in the crystal structure of manganese oxide including, but not limited to, one or a combination of layered structures (phyllomanganate), tunnel structures (tectomanganate), spinels, turbostratic structures, ramstellites and amorphous, as well as alpha, beta, delta, epsilon, and gamma phases. The modifications may also result in an increase in the lattice spacing, between 0.1 nm and 1 nm, preferably between 0.2 nm and 0.7 nm. In another observed reaction mechanism, electrochemical cycling of a manganese oxide structure may involve comproportionation and disproportionation reactions where Mn^{II}+Mn^{IV}→2 Mn^{III}, and 2 Mn^{III}→Mn^{II}+Mn^{IV} respectively. This may result in structural changes, including vacancies at or adjacent to the reaction site, conversion to or from phyllomangnate to tectomangnate structures, or to or from ordered to disordered, crystalline to amorphous.

In some embodiments, a manganese oxide structure is structured to contribute to uptake or release of electrochemically active one or more of monovalent and multivalent ions including but not limited to lithium, sodium, potassium, cerium, calcium, aluminum, zinc, copper, titanium, chromium, cobalt, rubidium, iron, molybdenum, nickel, vanadium, silicon, manganese, magnesium, silicon, calcium, zirconium, ruthenium, indium, tin, and silver. In addition to the aforementioned ions, other active species for reversible storage may include one, more, or a combination of water, oxide, hydroxide, sulfate, nitrate, phosphate, halides, or protons. All active species may exist in any of a variety of positions in a manganese oxide lattice including but not limited to single, double, or triple corner sharing sites; single, double, or triple edge sharing sites; inclusions in the lattice by filling vacancy sites, at defect sites or in the form of an ion exchange reaction wherein one or more of the cations and anions comprising baseline manganese oxide structure, as described above, are replaced by the electrochemically active monovalent and multivalent.

In some embodiments, one or more of a solid and semi-solid (e.g., gel or gelatinous) surface layer (e.g., interfacial layer) forms at a cathode and electrolyte interface, wherein the solid or semi-solid surface layer may serve one or both of the following purposes: (1) act as an active layer to reversibly store ions, and (2) act as a passivating layer to prevent undesired side reactions at the cathode. This interface may include one or more or combinations of lithium, sodium, potassium, cerium, calcium, aluminum, zinc, copper, titanium, chromium, cobalt, rubidium, iron, molybdenum, nickel, vanadium, silicon, manganese, magnesium, silicon, calcium, zirconium, ruthenium, indium, tin, and silver, and oxides, hydroxides, oxide-hydroxide, sulfate, phosphate, nitrate, sulfide, phosphide, and nitrides.

An electrode suitable for use as a cathode in an electrochemical cell described herein may include vanadium oxide (e.g., in one or more vanadium oxide structures, such as particles, such as powdered particles, ordered and disordered structures, spheres, sheets, fibers, or pillars, or films) with a stoichiometry of VₓO_{y}, wherein x ranges between 1 and 2 and y ranges between 2 and 5 for the stable compound and between 1 and 4 for x and 1 and 9 for y for the anionic and cationic form (for example, VO₂⁻¹, V₃O₄⁺¹). The vanadium oxide structure may be one or a combination of monoclinic, rutile, orthorhombic, or trigonal. The vanadium oxide structure may further have one or more of vacancies, defects, and interstitial voids (e.g., sites, spaces). The vanadium oxide structure may further include monovalent or multivalent cations including but not limited to lithium, potassium, calcium, sodium, aluminum, gallium, indium, bismuth, zinc, copper, cerium, lanthanum, rubidium, titanium, iron, tin, lead, manganese, magnesium, cobalt, chromium, nickel, and silver. These may exist in one or more of (i) between the layers of vanadium oxide, (ii) at vacancies, (iii) as pillars, (iv) at interstitial voids (e.g., sites, spaces), or (v) at defect sites. In some embodiments, the vanadium oxide structure may include anions, including but not limited to one or a combination sulfate, oxides, hydroxide, oxide-hydroxide, triflates, sulfonimides, oxalatoborates, acetates, phosphate, nitrate, sulfide, nitride, nitrite, and halides. The vanadium oxide structure may further be hydrated.

In some embodiments, a vanadium oxide structure may undergo a carbonization process wherein the structure(s) are coated with carbon or have carbon interspersed within each manganese oxide particle. This process may involve the incorporation of a conductive carbon additive to the particle including, but not limited to, carbon black, carbon nanotubes, graphene sheets, acetylene black, carbon fiber, or some combination thereof. This process may also involve the incorporation of a carbon precursor into the active particle either before, during, or after particle synthesis followed by subsequent carbonization of that precursor. This precursor can include, but is not limited to, a monosaccharide, a disaccharide, an oligosaccharide, a polysaccharide, an organic acid, a polymer, a polyether, an aromatic carbon, or a combination thereof. The carbonization process may involve techniques including, but not limited to, hydrothermal reaction, physical mixing, wet chemistry, electrochemical coating, spray pyrolysis, and spray drying.

In some embodiments, a vanadium oxide structure may be present as a composite with another compound, or multiple other compounds. These compounds may be selected from metals, nitrates, nitrites, nitrides, sulfates, sulfites, sulfides, carbonates, carbides, phosphates, phosphites, acetates, oxides, hydroxides, oxalates, or halides of lithium, potassium, calcium, sodium, aluminum, gallium, indium, bismuth, zinc, copper, cerium, lanthanum, rubidium, titanium, iron, tin, lead, manganese, magnesium, cobalt, chromium, nickel, and silver. These other compounds may be present, for example, in the range of 0.01% to 50% of the total amount. This composite may be formed during the chemical, electrochemical, or mechanical synthesis of primary particles, or the chemical, electrochemical, or mechanical synthesis of secondary particles including the primary particles.

In some embodiments, a vanadium oxide structure is able to reversibly contribute to uptake and release of electrochemically active monovalent and multivalent ions including but not limited to lithium, sodium, potassium, calcium, cerium, aluminum, zinc, copper, titanium, cobalt, chromium, iron, molybdenum, nickel, vanadium, silicon, manganese, magnesium, silicon, calcium, zirconium, ruthenium, indium, tin, and silver. The reversible uptake and release may occur at storage sites that exist in vacancies within the vanadium oxide structure or at defect sites or in the form of an ion exchange reaction wherein one or more of the cations and anions comprising of the baseline vanadium oxide structure, as described above, are replaced by the electrochemically active monovalent and multivalent ions.

In an extension of the above reaction mechanism, reversible uptake and release of electrochemically active monovalent and multivalent ions may also be facilitated by vanadium within vanadium oxide undergoing a transition of oxidation states. An example of such an electrochemical reaction would include:

V₂^{[+5]}O₅+M⁺²+2e−→V₂^{[+4]}M^{[+2]}O₅, wherein M is a metal ion that can be monovalent or multivalent (as in this example).

Some embodiments describes a reversible uptake and release of electrochemically active monovalent and multivalent ions enabled by vanadium dissolution from the baseline vanadium oxide structure.

In some embodiments, a vanadium oxide structure can undergo a structural modification or material property changes through a pre-treatment process, a formation process, or during electrochemical cycling, that would then act as the active electrode material for reversible uptake and release of electrochemically active monovalent and multivalent ions. The general repeating unit of such stoichiometries could include MₓV_{y}O_{z}, V_{y}O_{z}Aₙ, and MₓV_{y}O_{z}Aₙ, wherein M is a cation and A is an anion, while the structure itself can have one or more cations and anions of different kinds characterized by, as an example, M1ₓ₁M2ₓ₂V_{y}O_{z}, V_{y}O_{z}A1ₙ₁A2ₙ₂, M1ₓ₁M2ₓ₂V_{y}O_{z}A1ₙ₁A2ₙ₂, and so on. The modifications may include insertion of anions or cations in interstitial voids (e.g., sites, spaces), vacancies, and defects within the vanadium oxide structure. The modifications may further entail changes in the crystal structure of vanadium oxide including, but not limited to, one or a combination of layered structures, tunnel structures, turbostratic structures, spinels, and amorphous. The modifications may also result in an increase in the lattice spacing, between 0.1 nm and 1 nm, preferably between 0.2 nm and 0.7 nm.

### Separators

In some embodiments, a solid layer or semi-solid (e.g., gel or gelatinous) surface layer described herein is disposed between two electrodes and is structured as a separator. The separator may include one or more of an alloy, or a chemically bonded combination of one or more of the following species: sodium, potassium, calcium, iron, aluminum, silicon, tin, carbon, titanium, manganese, vanadium, magnesium, zinc, nickel, zirconium, carbon, oxygen, nitrogen, sulfur, nitrates, sulfates, nitrides, sulfides, triflates, sulfonimides, oxalatoborates, phosphates, oxides, hydroxides, oxide hydroxides, and water.

A separator may be coated ex situ directly on to an anode or a cathode or both the anode and cathode. The coating technique can include, but is not limited to, wet chemical reaction, physical vapor deposition, chemical vapor deposition, atomic layer deposition, sintering, pressing, hot pressing, extrusion, die casting, slot-die coating, and doctor-blade coating. A separator (e.g., coating layer) may include particles, such as powdered particles, ordered and disordered structures, spheres, sheets, fibers, or pillars. The particles may facilitate ion conduction. The coating layer may be further mixed with polymers to assist in adhesion and cohesion or to enable formation of a polymeric matrix to contain the species that compose the separator. The coated layer may be further subjected to calendaring to increase adhesive strength or layer uniformity. A temperature treatment such as annealing may also be employed. Further, a separator may or may not be used in conjunction with a liquid electrolyte (e.g., may be used with a solid electrolyte).

A separator may be an electrochemically active layer (e.g., structured to store and release ions in at least a portion of the separator), for example a surface layer that acts as a separator and an electrochemically active layer. A separator may be hydrophobic (e.g., inherently or as a result of a surface treatment) (e.g., wherein a surface of the separator is hydrophobic). A separator may be hydrophobic (e.g., inherently or as a result of a surface treatment) (e.g., wherein a surface of the separator is hydrophobic). A separator may be an electrochemically active layer in the electrochemical cell.

An electrochemical cell may further include a second separator (e.g., comprising pores of a size corresponding to one or more ions). A second separator may include one or more materials selected from the group consisting of PVDF, cellulose, nylon, sulfones, polyurethanes, polypropylene, ceramics (e.g., silica, alumina, silicates), and aluminates.

### Electrolytes

An electrochemical cell (e.g., battery such as a rechargeable battery (e.g., an rechargeable ion battery, such as an aluminum ion battery) can include a solid or liquid (e.g., aqueous) electrolyte. In some embodiments, multiple electrolytes are included. In some embodiments, an anode is in contact with one electrolyte and a cathode is in contact with another electrolyte. The two electrolytes may be in contact with each other, may be miscible or immiscible with each other, or may be separated by a separator. The electrolyte may comprise a solvent including one, more, or a combination of lithium, sodium, potassium, calcium, manganese, aluminum, silicon, aluminates, silicates, cerium, rubidium, nickel, copper, bismuth, indium, gallium, tin, zinc, tungsten, oxides, hydroxides, oxide-hydroxides, nitrates, nitrites, sulfates, sulfites, carbonates, carbides, acetates, halides, sulfonimides, triflates, tris(trimethylsilyl) borate, citric acid, oxalic acid, tartaric acid, salicylic acid, acetic acid, adipic acid, sebacic acid, boric acid, nitric acid, phosphoric acid, sulfuric acid, hydrochloric acid, and water.

In some embodiments, a charge storage mechanism for an electrochemical cell relies on one or both of ionic contributions from the electrolyte, wherein the ions are contributed by one or more of an anode, a cathode, and an existing composition of the electrolyte. In some embodiments, the reaction chemistry may entail a redox reaction or an intercalation comprising of one or more of phosphates, phosphites, phosphides, phosphorus, sulfates, sulfites, sulfates, sulfur, nitrates, nitrites, nitrides, nitrous oxides, nitrogen, chlorides, chlorates, fluorides, fluorates, and perchlorates. Such a redox reaction or intercalation may occur in conjunction with one or more of other ion transport phenomenon including redox reactions or intercalation of cations including one, more, or a combination of lithium, sodium, potassium, calcium, cerium, aluminum, zinc, copper, titanium, rubidium, chromium, cobalt, iron, molybdenum, tungsten, carbon, nickel, vanadium, silicon, manganese, magnesium, silicon, calcium, zirconium, ruthenium, indium, tin, gallium, bismuth, silver, gold, and platinum. Such a redox reaction or intercalation may also occur in conjunction with one or more of other ion transport phenomenon including redox reactions or intercalation of anions including one, more, or a combination of hydroxide, oxide, oxide hydroxide, carbide, oxychloride, oxynitrate, carbonate, triflate, sulfonimide, oxalatoborate, triflates, sulfonimides, oxalatoborates, acetates, and nitriles. A charge storage mechanisms may further entail one or both of oxidation and reduction reactions of the anode, the cathode, or both the anode and cathode. Reactions may proceed in the ionic state or in the gaseous state, wherein a gas participating in the redox reaction may entail one or more of hydrogen, oxygen, nitrogen, nitrogen oxides, sulfur oxides, phosphates, and halides.

In general, an electrolyte used in an electrochemical cell in the present disclosure comprises at least one solvent and a salt (e.g., one salt). A solvent may be chosen from: ethylene carbonate, butylene carbonate, fluoroethylene carbonate, vinylene carbonate, sulfolane, gamma-butyrolactone, dimethyl carbonate, diethyl carbonate, dipropyl carbonate, dibutyl carbonate, ethyl methyl carbonate, methyl propyl carbonate, ethyl propyl carbonate, propylene carbonate, acetonitrile, isopropanol, ethanol, methanol, 1-propanol, 1,2-dimethoxyethane, dimethyl sulfoxide, acetic acid, sulfuric acid, nitric acid, phosphoric acid, boric acid, aniline, and water. Salts that may be used in an electrolyte include hydroxides, sulfates, phosphates, halides, nitrates, triflates, sulfonimides, and oxalatoborates of lithium, sodium, potassium, calcium, magnesium, strontium, cerium, titanium, vanadium, chromium, manganese, iron, cobalt, nickel, copper, zinc, aluminum, silicon, zirconium, silver, cadmium, indium, tin, and tungsten.

In some embodiments, the addition of a buffer solution to an electrolyte is used to limit changes in pH occurring in a cell during cycling, maintaining pH between 1 and 10, preferably between 2 and 6. Such buffer solutions include but are not limited to a weak acid buffer such as solutions of sodium phosphate-citric acid, sodium citrate-citric acid, sodium acetate-acetate acid or basic buffers such as solutions of glycine-sodium hydroxide, monosodium phosphate-disodium phosphate.

In one example, a metallic foil of aluminum is used as the negative electrode and cycled against a titanium foil (current collector substrate) with a manganese cation containing aqueous electrolyte. On charge, manganese cations are oxidized at the titanium foil releasing protons into the electrochemical cell. In some embodiments, electrons react at the negative electrode with protons to form hydrogen gas. In some embodiments, the electrons react at the negative electrode with a gel-like (semi-solid) or solid surface layer structure present at the surface of the aluminum foil which accommodates the storage of active ions. The overall electrochemical activity leads to generation of protons in the system. On discharge, manganese species present at the cathode are reduced while oxidation of hydrogen to H+ and/or ion de-intercalation from the gel-like or solid structure at the interface of the aluminum foil occurs at the negative electrode, leading to an overall consumption of protons in the system.

In some embodiments, the aqueous electrolyte comprises one or more anionic surface active agents selected from the group consisting of sodium dodecylsulfate, sodium decylsulfate, ammonium lauryl sulfate, sodium laureth sulfate, sodium lauryl sarcosinate, sodium myreth sulfate, sodium pareth sulfate, sodium stearate, sodium lauryl sulfate, ammonium laureth sulfate, sodium N-lauroyl-N-methyltaurate, sodium tetradecyl sulfate, sodium dodecylsulfonate, sodium dodecylbenzenesulfonate, and sodium dialkylsulfosuccinate that were tested in the concentrations of 0.1 μM to 10 M, preferably between 0.1 μM and 1 M.

In some embodiments, the aqueous electrolyte comprises one or more nonionic surface-active agents selected from the group consisting of Triton X-100, Triton X-45, Triton X-165, Triton X-305, Triton X-405, Triton CF-32, Polysorbate 20, Span 80, Tergitol 15-S-3, Tergitol 15-S-9, Brij-35, Tetronic 150R1, and Pluronic F68 that were tested in the concentrations of 0.1 μM to 10 M, preferably between 0.1 μM and 5 M.

In some embodiments, the aqueous electrolyte comprises one or more zwitterionic surface active agents selected from the group consisting of cocamidopropyl betaine, amidosulfobetaine-16, lauryl-N,N-(dimethylammonio)butyrate, lauryl-N,N-(dimethyl)-glycinebetaine, 3-[(3-cholamidopropyl)dimethylammonio]-1-propanesulfonate, 3-([3-cholamidopropyl]dimethylammonio)-2-hydroxy-1-propanesulfonate, 3-[(3-cholamidopropyl)dimethylammo-nio]-1-propanesulfonate, lauryl-N,N-(dimethyl)-propanesulfonate, 3-(4-tert-butyl-1-pyridinio)-1-propanesulfonate, 3-(1-pyridinio)-1-propanesulfonate, 3-(benzyl-dimethylammonio)propanesulfonate, lauryldimethylamine N-oxide that were tested in the concentrations of 0.1 μM to 10 M, preferably between 0.1 μM and 5 M.

In some embodiments, the aqueous electrolyte comprises one or more cationic surface-active agent selected from the group consisting of cetyl trimethyl ammonium bromide, trimethylammoniumhexadecyl chloride, alkyldimethylbenzyl ammonium chloride, dodecyltrimethylammonium bromide, dodecyltrimethylammonium bromide, and 1-dodecylpyridinium bromide that were tested in the concentrations of 0.1 μM to 10 M, preferably between 0.1 μM and 5 M.

In some embodiments, the aqueous electrolyte comprises one of more organic and inorganic additives selected from the group consisting ammonium borate, sodium silicate, 30,60-dihydroxyspiro[2-benzofuran-3,90-xanthene]-1-one, (E)-4-((2 chlorophenyl)diazenyl)naphthalene-1,5-diol, (E)-4-(o-tolyldiazenyl)naphthalene-1,5-diol, and (E)-4-((2 methoxyphenyl)diazenyl)naphthalene-1,5-diol, N-thiazolyl-2-cyanoacetamide derivatives, i.e., N-(4-phenylthiazol-2-yl)-2-phenylazo-2-cyanoacetamide, N-(4-phenylthiazol-2-yl)-2-(p-tolylazo)-2-cyanoacetamide, and N-(4-phenylthiazol-2-yl)-2-(p-methoxyphenylazo)-2-cyanoacetamid, 1-(4-((2-hydroxy-3 nitrophenyl)diazenyl)phenyl)propan-1-one, 1-(4-((3-amino-2-hydroxyphenyl)diazenyl)phenyl)propan-1-one, and 1-(4-((2,4,6-trihydroxyphenyl)diazenyl)phenyl)propan-1-one, 50-amino-2,4-dihydroxy-400-methyl-1,10:30,100-terphenyl-40,60-dicarbonitrile (ABDN-1), 50-amino-2,200,4-trihydroxy-1,10:30,100-terphenyl-40,60-dicarbonitrile (ABDN-2), and 50-amino-2,4,400-trihydroxy-300-methoxy-1,10:30,10-terphenyl-40,60-dicarbonitrile (ABDN-3), polyoxyethylene (20) sorbitanmonooleate (Tween 80), 3-ethyl-4-amino-mercapto-1,2,4-triazole, 3-methyl-4-amino-5-mercapto-1,2,4-triazole (MAMT), 3-(4-hydroxy-3-methoxy-phenyl)-1-(2-hydroxy-phenyl)-propenone (HMPHPP), 1-(4-hydroxyphenyl)-3-(2-hydroxyphenyl)-propenone (HPHPP), 2-propanol, 3-methylpyridine, Crystal violet dye, -(4-nitrophenylazo)-1-naphthol (44NIN), 8-hydroxyquinoline (8-HQ), polymethacrylate, amino-1,2,4-triazole-5-thiol (ATAT), tryptamine, tryptophane, monoethanolamine (MEA), o-phenylenediamine, anthranilic, ferrous gluconate, calcium gluconate, diisopropyl thiourea (DISOTU), cerium dibutylphosphate, licylaldoxime (SAL), 2-mercaptobenzothiazole, 8-HQ, thioacetamide, quinaldic acid, a-benzoionoxime, 2-(2-hydroxyphenyl) benzoxazole, dithioox-amide, cuprizone, and cupferron, dimercapto-1,3,4-thiadiazolate (DMTD), 2,4-triazole (TA), 3-amino-1,2,4-triazole (ATA), benzotriazole (BTA), and 2-mercaptobenzothiazole (2-MBT), -butine-1,4-diol and potassium sodium tartrate, propargyl alcohol, 8-aminoquinoline (8-AQ) and 8-nitroquinoline (8-NQ), -pyrrolidine dithio-carbamate (PDTC), benzamide (BA), 4-aminobenzenesulfonamide (ABSA), and thioacetamide (TAA) that were tested in concentration of 50 ppm to 10M, preferably between 50 ppm to 1M.

In some embodiments, the aqueous electrolyte comprises one or more metal oxides where the metals included zinc, iron, aluminum, cerium, titanium, bismuth, indium, barium, cobalt, nickel, copper, zirconium, niobium, tantalum, manganese, tin, indium, chromium, lead, and tungsten, that were tested in the concentrations of 0.01 to 20 g/L.

In some embodiments, the aqueous electrolyte comprises one or more additives selected from the group consisting of bismuth nitrate, indium nitrate, gallium nitrate, sodium carboxymethylcellulose, tris(trimethylsilyl) borate, P-nitrophenol, citric acid, oxalic acid, tartaric acid, salicylic acid, acetic acid, adipic acid, sebacic acid, boric acid, nitric acid, phosphoric acid, sulfuric acid, hydrochloric acid, and nitric acid that were tested in the concentrations of 1 mM to 10 M, preferably between 1 mM and 1M.

In some embodiments, the electrolyte comprises two or more solvents selected from the group consisting of water, methanol, isopropanol, ethanol, sulfolane, acetonitrile, succinonitrile, dimethylsulfoxide, tetrahydrofuran, toluene, propylene carbonate, benzene, dichloromethane, dimethylformamide, nitrobenzene, dichlorobenzene, ethylene glycol, 1,1,2,2-tetrafluoroethyl-2′,2′,2′-trifluoroethyl ether, and diethyl carbonate.

In some embodiments, a solid state electrolyte (e.g., solid polymer electrolyte) comprises (e.g., at least 20%, at least 30%, at least 50 wt. %, at least 70 wt. %, at least 80 wt. %, at least 90 wt. %, or at least 95 wt. % of) one or more materials each having a stoichiometry of M1¹⁺ₓN1ₚ or M1²⁺ₓN1ₚ or M1³⁺ₓN1ₚ or M1⁴⁺ₓN1ₚ or M1¹⁺ₓN1ₚN2_{q} or M1²⁺ₓN1ₚN2_{q} or M1³⁺ₓN1ₚN2_{q} or M1⁴⁺ₓN1ₚN2_{q} or M1¹⁺ₓM2²⁺_{y}N1ₚ or M1¹⁺ₓM2³⁺_{y}N1ₚ or M1¹⁺ₓM2⁴⁺_{y}N1ₚ or M1²⁺ₓM2³⁺_{y}N1ₚ M1²⁺ₓM2⁴⁺_{y}N1ₚ or M1³⁺ₓM2⁴⁺_{y}N1ₚ or M1¹⁺ₓM2²⁺_{y}N1ₚN2_{q} or M1¹⁺ₓM2³⁺_{y}N1ₚN2_{q} or M1¹⁺ₓM2⁴⁺_{y}N1ₚN2_{q} or M1²⁺ₓM2³⁺_{y}N1ₚN2_{q} or M1²⁺ₓM2⁴⁺_{y}N1ₚN2_{q} or M1³⁺ₓM2⁴⁺_{y}N1ₚN2_{q} or M1¹⁺ₓM2²⁺_{y}M3³⁺_{z}N1ₚ or M1¹⁺ₓM2²⁺_{y}M3⁴⁺_{z}N1ₚ or M1²⁺ₓM2³⁺_{y}M3⁴⁺_{z}N1ₚ or M1¹⁺ₓM2²⁺_{y}M3³⁺_{z}N1ₚN2_{q} or M1¹⁺ₓM2²⁺_{y}M3⁴⁺_{z}N1ₚN2_{q} or M1²⁺ₓM2³⁺_{y}M3⁴⁺_{z}N1ₚN2_{q} or M1¹⁺ₓM2²⁺_{y}M3³⁺_{z}M4⁴⁺ₛN1ₚ or M1¹⁺ₓM2²⁺_{y}M3³⁺_{z}M4⁴⁺ₛN1ₚ N2_{q}, wherein each M is a monovalent, bivalent, trivalent or tetravalent atom and each N a functional group, for example selected from the group consisting of hydroxide, alkoxide, peroxide, superoxide, nitrate, nitrite, sulfate, sulfite, sulfide, carbonate, phosphate, phosphate, phosphide and halide. The one or more materials can act as an ion conducting matrix in a solid state electrolyte.

In some embodiments, a solid state electrolyte comprises one or more materials each having a stoichiometry of M1ₓN1ₚ or M1ₓN1ₚN2_{q} or M1ₓM2_{y}N1ₚ or M1ₓM2_{y}N1ₚN2_{q} or M1ₓM2_{y}M3_{z}N1ₚ or M1ₓM2_{y}M3_{z}N1ₚN2_{q} or M1ₓM2_{y}M3_{z}M4ₛN1ₚ or M1¹⁺ₓM2_{y}M3_{z}M4ₛN1ₚN2_{q} wherein each M is a monovalent or multivalent atom, which may be selected from the group consisting of transitional metals and wherein each exist in one or more oxidation states or may otherwise undergo transition from one oxidation state to another during storage, no load conditions or electrochemical cycling.

In some embodiments, a solid state electrolyte may comprise a material having a stoichiometry represented by the general notation M1ₓM2_{y}M3_{z} . . . N1ₚN2_{q}N3ᵣ . . . and so on.

A solid state electrolyte may further comprise (e.g., at least 50 wt. %, at least 70 wt. %, at least 80 wt. %, at least 90 wt. %, or at least 95 wt. % of) a polymer. The polymer may serve one or both of the following purposes: (i) providing a structural network, and (ii) serving as ion transport media. Polymers that may be used include, but are not limited to, polymers that comprise repeat units of one or more of an ethylene oxide, a propylene oxide, an alizarin, an alginate, a quinones, a hydroxyquinones, a hydroxyquinoline, or cellulosic or natural or modified natural polymers, or synthetic fluorinated polymers such as polyvinylidene fluoride (PVDF) and polytetrafluoroethylene (PTFE).

In some embodiments, a solid state electrolyte may further comprise one or more of one or more salts, one or more bases, and one or more acids. Some examples of salts that may be used include, but are not limited to, hydroxide, alkoxide, peroxide, superoxide, nitrate, nitrite, sulfate, sulfite, sulfide, carbonate, phosphate, phosphate, phosphide and halide salts of one or more of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, rubidium, platinum, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, and copper. Some examples of acids that may be used include, but are not limited to, phosphoric acid, nitric acid, sulfuric acid, hydrochloric acid, sulfurous acid, triflic acid, hydrofluoric acid, peracetic acid, boric acid, uric acid, citric acid, hydroiodic acid, carbonic acid, oxalic acid, bromic acid, chromic acid, formic acid, ascorbic acid, and acetic acid. Some examples of bases that may be used include, but are not limited to, hydroxides of sodium, potassium, calcium, magnesium, manganese, lithium, zinc, zirconium, cerium, tin, titanium, aluminum, ammonium, iron, indium, molybdenum, nickel, platinum, palladium, ruthenium, silver, vanadium, and copper.

In some embodiments, a solid state electrolyte may comprise one or more ceramics such as, for example, aluminum oxide, ammonium antimony tungsten oxide, barium titanate, strontium titanate, bismuth strontium calcium copper oxide, boron oxide, boron nitride, ferrites, lead zirconate titanate, magnesium diboride, porcelain, sialon, silicon, carbide, silicon, nitride, titanium carbide, uranium oxide, yttrium barium copper oxide, zinc oxide, cesium oxide, zirconium oxide, vanadium oxide, tin oxide, iron oxide, tungsten chloride oxide, beryllium oxide, bismuth oxide, lithium oxide, lead oxide, manganese oxide, magnesium oxide, nickel oxide, titanium oxide, cadmium oxide, copper oxide, indium oxide, and silicon oxide.

A solid state electrolyte may further include water molecules, such as water molecules disposed in a crystal structure (e.g., water of hydration).

A solid state electrolyte may be free-standing in nature or may be applied (e.g., deposited) on an electrode (e.g., an anode or cathode), for example as a thin film, through a process including, but not limited to, one or more of chemical vapor deposition, spin coating, blade coating, atomic layer deposition, slot-die coating, comma/reverse-comma coating, electro-deposition, drop casting, Langmuir-Blodgett film formation, gravure, intaglio, embossing, dip-coating, reactive etching, high-pressure gas synthesis, multi-step kiln firing, reductive and oxidative annealing.

### Dynamic Electrochemical Environment

In some embodiments, an electrochemical cell comprises an anode comprising an aluminum structure having a surface layer wherein the surface layer comprises of one or more materials having a stoichiometry of M1ₓN1ₚ or M1ₓN1ₚN2_{q} or M1ₓM2_{y}N1ₚ or M1ₓM2_{y}N1ₚN2_{q} or M1ₓM2_{y}M3_{z}N1ₚ or M1ₓM2_{y}M3_{z}N1ₚN2_{q} or M1ₓM2_{y}M3_{z}M4ₛN1ₚ or M1ₓM2_{y}M3_{z}M4ₛN1ₚN2_{q}, wherein each M is a monovalent or multivalent atoms and each N is a functional group, such as, for example, hydroxide, alkoxide, peroxide, superoxide, nitrate, nitrite, sulfate, sulfite, sulfide, carbonate, phosphate, phosphate, phosphide or halide.

In some embodiments, a surface layer comprises a material comprising multiple atoms and functional groups denoted by the general formula M1ₓM2_{y}M3_{z} . . . N1ₚN2_{q}N3ᵣ . . . and so on, to create one or more components of one or more complexity.

In some embodiments, a surface layer of an aluminum structure of an anode degrades (e.g., dissolves) during discharge or charge of an electrochemical cell and/or reforms (e.g., restructures, redeposits, and/or reorders) during discharging or charging of the electrochemical cell. Thus, a surface layer may be transient in that its state (e.g., presence) depends on a charge state of the electrochemical cell.

In some embodiments, the reformation may be achieved through a change in the local surface pH or overall global electrolyte pH that is incorporated through specific charging or discharging pattern including one or more of steady current or pulsed current with different amplitude and/or frequencies, potentiostatic or galvanostatic hold, potentiostatic or galvanostatic ramp, overcharge potential, overcharge current, high voltage pulsed charge or low voltage pulsed charge.

In some embodiments where an electrochemical cell has a flow battery configuration, reformation can be achieved through partial or complete refilling of electrolyte in an electrochemical chamber. This can be achieved through incorporation of diluted acids, typically within a molarity range of 0.01-1M, to the electrochemical cell at a state of charge ranging from 0 to 100%. In some embodiments, bases within a molarity range of 0.01-4M may also be added to the electrochemical cell prior to or during discharge, at a depth of discharge ranging from 0 to 100%.

In some embodiments, an electrolyte comprising a salt of one or more of M1¹⁺, M1²⁺, M1³⁺ and M1⁴⁺ is refilled into an electrochemical cell prior to or during charging. In some embodiments, the electrochemical cell is flushed with distilled or deionized water prior to refilling the electrochemical cell with an electrolyte disclosed herein.

In some embodiments, a small concentration of an acid or a base is added/injected periodically to an electrochemical cell or a flow battery to assist in dissolution and reformation of a surface layer, thereby improving performance of the electrochemical cell or flow battery. The periodic injection may be determined based on the state of health of the battery and a pressure release valve prevents an overflow of the electrolyte within the electrochemical cell.

### Current Collector Substrate

In some embodiments, an electrode comprises an aluminum metal current collector substrate comprising a surface layer wherein the surface layer comprises (e.g., at least 50 wt. %, at least 70 wt. %, at least 80 wt. %, at least 90 wt. %, or at least 95 wt. % of) one or more materials each having a stoichiometry of M1¹⁺ₓN1ₚ or M1²⁺ₓN1ₚ or M1³⁺ₓN1ₚ or M1⁴⁺ₓN1ₚ or M1¹⁺ₓN1ₚN2_{q} or M1²⁺ₓN1ₚN2_{q} or M1³⁺ₓN1ₚN2_{q} or M1⁴⁺ₓN1ₚN2_{q} or M1¹⁺ₓM2²⁺_{y}N1ₚ or M1¹⁺ₓM2³⁺_{y}N1ₚ or M1¹⁺ₓM2⁴⁺_{y}N1ₚ or M1²⁺ₓM2³⁺_{y}N1ₚ M1²⁺ₓM2⁴⁺_{y}N1ₚ or M1³⁺ₓM2⁴⁺_{y}N1ₚ or M1¹⁺ₓM2²⁺_{y}N1ₚN2_{q} or M1¹⁺ₓM2³⁺_{y}N1ₚN2_{q} or M1¹⁺ₓM2⁴⁺_{y}N1ₚN2_{q} or M1²⁺ₓM2³⁺_{y}N1ₚN2_{q} or M1²⁺ₓM2⁴⁺_{y}N1ₚN2_{q} or M1³⁺ₓM2⁴⁺_{y}N1ₚN2_{q} or M1¹⁺ₓM2²⁺_{y}M3³⁺_{z}N1ₚ or M1¹⁺ₓM2²⁺_{y}M3⁴⁺_{z}N1ₚ or M1²⁺ₓM2³⁺_{y}M3⁴⁺_{z}N1ₚ or M1¹⁺ₓM2²⁺_{y}M3³⁺_{z}N1ₚN2_{q} or M1¹⁺ₓM2²⁺_{y}M3⁴⁺_{z}N1ₚN2_{q} or M1²⁺ₓM2³⁺_{y}M3⁴⁺_{z}N1ₚN2_{q} or M1¹⁺ₓM2²⁺_{y}M3³⁺_{z}M4⁴⁺ₛN1ₚ or M1¹⁺ₓM2²⁺_{y}M3³⁺_{z}M4⁴⁺ₛN1ₚ N2_{q}, wherein each M is a monovalent, bivalent, trivalent or tetravalent atom, for example selected from the group consisting of sodium, potassium, calcium, barium, cesium, scandium, cadmium, magnesium, iron, manganese, lithium, zinc, zirconium, niobium, yttrium, molybdenum, hafnium, osmium, nickel, cobalt, germanium, beryllium, mercury, tungsten, platinum, rubidium, ruthenium, rhodium, palladium, antimony, tellurium, bismuth, arsenic, lead, lanthanum, europium, gadolinium, cerium, tin, chromium, vanadium, titanium, aluminum, tantalum, gallium, indium, silver, gold, and copper, and each N is a functional group, for example selected from the group consisting of hydroxide, alkoxide, peroxide, superoxide, nitrate, nitrite, sulfate, sulfite, sulfide, carbonate, phosphate, phosphate, phosphide and halide. Without wishing to be bound by any particular theory, monovalent, bivalent, or trivalent atom(s) can promoted ionic and electron conductivity through doping and/or act as a catalyst in one or more pseudo-capacitance and/or intercalation reactions. These atoms may also prevent undesirable side-reactions and subsequent uncontrolled chain reactions by reacting with and neutralizing deleterious electrolyte salts that may have precipitated out of an electrolyte solution. Functional group(s) may provide a structural template for atoms and assist in preventing or impeding corrosion in an electrochemical cell (e.g., an underlying portion of an anode thereof).

In some embodiments, an aluminum metal current collector substrate may comprise a surface layer comprising one or more materials having a stoichiometry of M1ₓN1ₚ or M1ₓN1ₚN2_{q} or M1ₓM2_{y}N1ₚ or M1ₓM2_{y}N1ₚN2_{q} or M1ₓM2_{y}M3_{z}N1ₚ or M1ₓM2_{y}M3_{z}N1ₚN2_{q} or M1ₓM2_{y}M3_{z}M4ₛN1ₚ or M1ₓM2_{y}M3_{z}M4ₛN1ₚN2_{q}, wherein M may include a monovalent and/or multivalent atom comprising of one or both rare earth metals, transition metals, alkali metals, alkaline earth metals, or main-group elements and wherein each exist in one or more oxidation states or may otherwise undergo transition from one oxidation state to another during storage, no load conditions or electrochemical cycling.

In some embodiments, an aluminum metal current collector substrate may comprise a surface layer comprising a material defined by the general stoichiometry M1ₓM2_{y}M3_{z} . . . N1ₚN2_{q}N3ᵣ . . . and so on, wherein each M is a monovalent or multivalent atom and each N is a functional group, such as, for example, hydroxide, alkoxide, peroxide, superoxide, nitrate, nitrite, sulfate, sulfite, sulfide, carbonate, phosphate, phosphate, phosphide or halide.

### Ionization Mechanism of Gaseous Species for Energy Storage Devices

In some embodiments, a semi-solid (e.g., gel or gelatinous) surface layer (e.g., interfacial layer) forms at an electrode (e.g., an anode) (e.g., at an interface of the electrode with an electrolyte or of the electrode with a surface layer thereon) during electrochemical cycling. In some embodiments, a solid surface layer (e.g., interfacial layer) forms at the electrode interface during electrochemical cycling. The composition of the semi-solid or solid surface layer may include one, more, or a combination of sodium, potassium, calcium, iron, aluminum, silicon, tin, titanium, manganese, magnesium, zinc, nickel, zirconium, carbon, nitrates, sulfates, nitrides, sulfides, triflates, sulfonimides, oxalatoborates, phosphates, oxides, hydroxides, oxide hydroxides, and water.

In some embodiments, a semi-solid (e.g., gel or gelatinous) surface layer (e.g., interfacial layer) forms at an electrode (e.g., cathode) (e.g., at an interface of the electrode with an electrolyte or of the electrode with a surface layer thereon) during electrochemical cycling. In some embodiments a solid interface forms at the cathode interface during electrochemical cycling. The composition of the gel or solid interface includes one, more, or a combination of sodium, potassium, calcium, iron, aluminum, silicon, tin, titanium, manganese, magnesium, zinc, nickel, zirconium, carbon, nitrates, sulfates, nitrides, sulfides, triflates, sulfonimides, oxalatoborates, phosphates, oxides, hydroxides, oxide hydroxides, and water.

The semi-solid (e.g., gel or gelatinous) surface layer (e.g., described above) may be generally considered to include one or both of organic and inorganic soft materials, either contributed by the electrolyte constituents or the electrode composition. This layer is generally structured to physically accommodate one or more of gaseous products (e.g., evolved during electrochemical cycling), cations, and anions. This layer may further ionize through a redox reaction of the gaseous by-products trapped in the bubble to harvest leakage electrons in the liquid-based electrochemical system. Use of a surface layer that can storage and/or ionize gas in an electrochemical cell can boost energy storage efficiency while reducing safety concerns, which saves a large portion of the cost for the form factor of safety maintenance. Thus, disclosed herein are novel ways to catalyze gaseous by-products (e.g., present as one or more bubbles) to an ion form through electrochemically functional gel. Such a method may involve electrochemical or chemical reactions between gas and a surface layer (e.g., a gel or gelatinous surface layer).

In some embodiments, an electrochemical cell undergoes gas evolution, for example where composition of the gas is one or more or a combination of nitrogen, oxygen, halides, sulfur, and hydrogen. A semi-solid (e.g., gel) or solid surface layer (e.g., interfacial layer) generally may enable a protonation reaction to capture hydrogen or hydronium ions from an evolved gas (e.g., evolved during electrochemical cycling). In some embodiments, an electrochemical cell undergoes gas evolution (e.g., during electrochemical cycling) wherein the composition of gas may be one or more of hydrogen or oxygen and wherein the semi-solid (e.g., gel or gelatinous) or solid interface enables a redox reaction to reversibly capture one or more of hydrogen ions, hydronium ions, and oxygen ions. In some embodiments, hydrogen ions, hydronium ions, or oxygen ions may further react within the gel or solid interface structure with one or more or a combination of sodium, potassium, calcium, iron, aluminum, tin, titanium, manganese, magnesium, zinc, nickel, zirconium, carbon, nitrates, sulfates, nitrides, sulfides, triflates, sulfonimides, oxalatoborates, phosphates, oxides, hydroxides, oxide hydroxides, and water. A gas may also be initially present as a by-product of fabrication (e.g., assembly or formation) of an electrochemical cell (e.g., a formation of a surface layer).

In some embodiments, a gas (e.g., evolved gas) could include one or more or a combination of hydrogen, oxygen, nitrogen, sulfur, water vapor, and halides.

In an extension of the aforementioned reaction enabled by a semi-solid (e.g., gel or gelatinous) or solid interface, the reaction may further be induced by introducing a short polarization pulse during charge or discharge of the electrochemical cell. For example a pulse of no more than 2 min and no less than 10 ms may be used.

In one example, an electrochemical cell incorporating an aluminum anode and a manganese oxide cathode was assembled in an aqueous electrolyte environment. The cell was assembled underneath of glass window to visualize microstructure evolution of the anode. The evolution of microstructure was measured by a Nikon optical microscope.

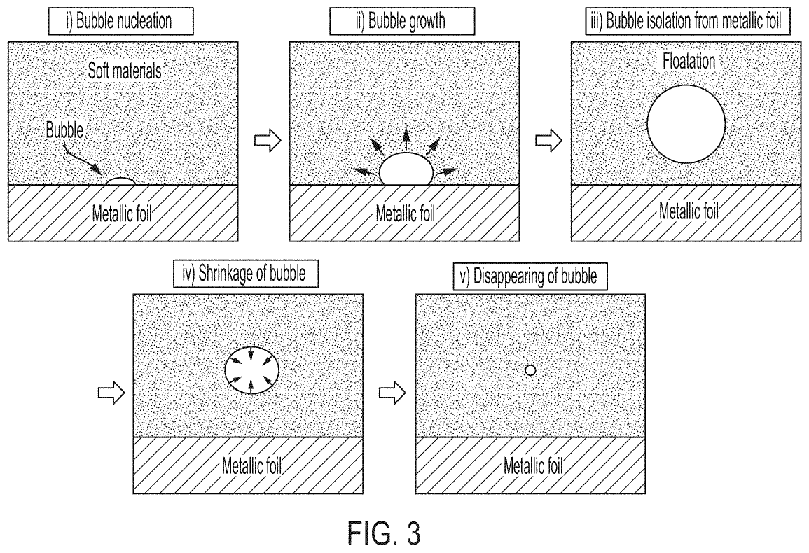

FIG. 3 shows a schematic of a decomposition process of gaseous by-products (e.g., trapped in bubble(s)) in a surface (e.g., interfacial) layer, for example as described above. The process may roughly involve five steps (two or more of which may occur simultaneously, for the same or different bubbles), depending on the chemical and electrochemical condition, i) bubble nucleation, ii) bubble growth, iii) bubble isolation, iv) shrinkage of the bubble and v) disappearing of the bubble. Bubbles may be nucleated during electrochemical cycling, in some embodiments preferentially during charge (e.g., induced by charging characteristics). Once the gas is nucleated, the bubbles continue to grow. As the process continues, the buoyant force will levitate the bubbles from the substrate (e.g., anode or cathode structure(s), such as vanadium oxide structure(s) or manganese oxide structure(s), or a current collector substrate). However, in some embodiments, a soft gelatinous material around the bubble effectively constrains it, maintaining it at a specific position and thereby preventing the bubble from escaping from the electrode vicinity. (Local voids in a solid surface layer may also provide at least some constraint.) Once an opposite electrical polarization is applied, preferably discharge (e.g., if preferentially nucleated during charge), the soft gel provides resonance chain reactions through chemical binding in the gel or an electric pathway (e.g., through an invisible route), resulting in shrinkage of the bubble. This process provides the electrochemical decomposition of gaseous by-products that are trapped in bubbles and enables efficient cycling of an electrochemical cell in an aqueous electrolyte environment. Moreover, it can simplify an electrochemical cell by reducing or eliminating the need for other gas mitigation components and/or improve lifetime (e.g., by prolonging the number of charge-discharge cycles before a fatal amount of gas is present in the battery).

### Surface Films for Electrochemical Energy Storage Systems

In some embodiments, an electrochemical cell includes a charge storage film that is structured to reversibly store charge during electrochemical cycling. A surface layer, whether ex situ or in situ formed, may be a charge storage film, for example depending on its morphology and chemical structure. A charge storage film may be or include one or more of organic, inorganic, and complex materials (e.g., combinations thereof).

A charge storage film may be in the form of a solid layer grown on top of one or both of two electrodes in a cell (e.g., the anode and cathode) on a surface thereof (top down) or deposited on one or both of two electrodes in a cell (e.g., the anode and cathode) on surface thereof (bottom up). The physical form of this film may be a solid layer with a cross-section thickness ranging from 10 nm to 1000 microns, and preferably between 1 micron and 300 microns. In some embodiments, the physical form of this film is gelatinous with a cross-section thickness ranging from 10 nm to 1000 microns, and preferably between 1 micron and 300 microns.

A charge storage film may be synthesized ex situ and applied as a layer on top of one or both of the electrodes, wherein the method of synthesis may be a wet chemical reaction, physical vapor deposition, chemical vapor deposition, atomic layer deposition, sintering, pressing, hot pressing, extrusion, die casting, slot-die coating, and doctor-blade coating. In the instance that a charge storage film is synthesized ex situ, the composition maybe mixed with conductive carbon and polymer binder additives in order to coat the film on to electrode(s). In some embodiments, a charge storage film may be formed in situ inside an electrochemical cell during the formation cycle or through regular cycling (e.g., charge and discharge).

In some embodiments, (e.g., where a charge storage film is synthesized ex situ) a charge storage film may include one or more or a combination of sodium, potassium, calcium, iron, aluminum, silicon, tin, carbon, titanium, manganese, vanadium, magnesium, zinc, nickel, zirconium, carbon, nitrates, sulfates, nitrides, sulfides, triflates, sulfonimides, oxalatoborates, phosphates, oxides, hydroxides, oxide hydroxides, and water, wherein the final charge storage film is comprised of one or more compounds with each compound further comprising species from the group described here. This charge storage film may further be able to reversibly store and release one or more ions, either through accommodating them within the structure (including but not limited to vacancies, interstitial voids (e.g., sites, spaces), defect sites) or through an ion exchange reaction.

In some embodiments, a charge storage film is effectively coated on to an active electrode. The coating may be carried out by vapor deposition processes, including physical vapor deposition, chemical vapor deposition, or atomic layer deposition, or through wet coating process including in situ (such as a layer built during a formation step or electrochemical cycling) or ex situ chemical reactions, draw-down, doctor-blade, slot-die, comma-coating, or reverse comma-coating.

In some embodiments, where a charge storage film is formed in situ during electrochemical cycling, this formation may proceed in the following steps: (i) formation of ion in an aqueous solution through ionization of one or more of anode, cathode, and electrolyte species; (ii) creation of an ion solvation shell; and (iii) chain reaction of the one or more ions by sharing of a functional group, such as nitrates, sulfates, nitrides, sulfides, triflates, halides, sulfonimides, oxalatoborates, phosphates, oxides, hydroxides, and oxide hydroxides between solvation shells. A charge storage film may further be able to reversibly store and release one or more ions, either through accommodating them within the structure (including but not limited to vacancies, interstitial (e.g., sites, spaces), defect sites) or through an ion exchange reaction.

In some embodiments, an ionized species is going to have water coordination to stabilize the charge through dipole in the water, thereby creating a solvation shell. The water solvation shell then makes a bridge through another solvation shell by sharing the anions. This process creates a chain reaction thereby making a gelatinous structure or gelation. The gelation of the solvation shell can further be initiated by adjusting pH and applied potential as the electrochemical cell at the anode-electrolyte and/or cathode-electrolyte interface tunes the pH. One of the factors or combination of both changing local pH and using electric potential can drive the reaction of ion gelation. Morphology such as the size and orderliness of species can be changed and optimized by ageing, pH of the solution, and temperature to the specific energy storage application.

In some embodiments, a gel is formed in situ during electrochemical cycling of an energy storage system. Once the gel is formed, the high negative solvation energy in the gel can host guest ions. The guest ions may include one, more or a combination of sodium, potassium, calcium, iron, aluminum, silicon, tin, titanium, manganese, magnesium, zinc, nickel, zirconium, proton, as well as one, more, or a combination of these ion solvation shells.

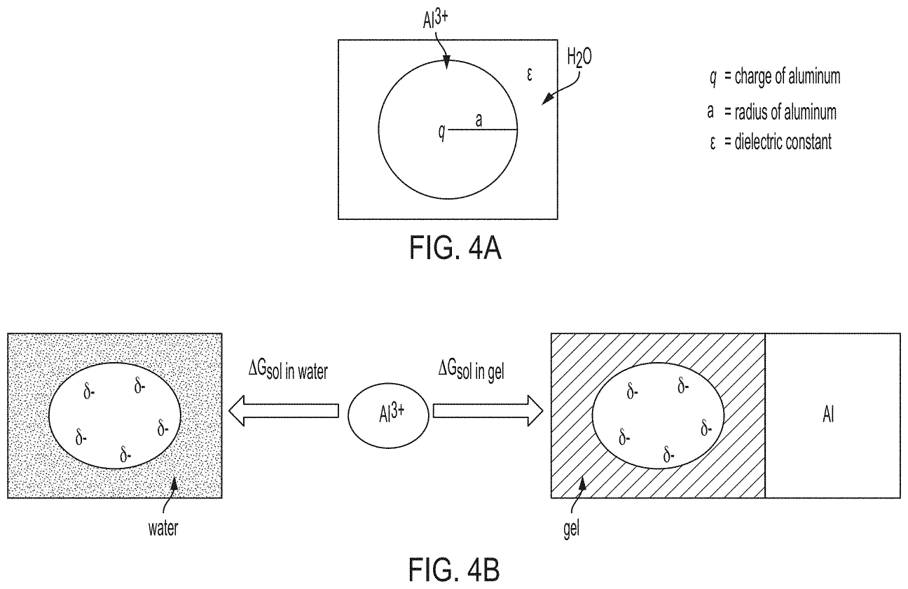

FIGS. 4A-4B show a schematic of the charge storage concept through increased negative solvation energy. The solvation energy is described by the charge and radius of the guest ions and the dielectric constant of the gel, as shown in FIG. 4A, where the energy can be determined using Eq. 1:

$$Δ {G}_{elec} = - \frac{{q}^{2}}{2 a} ( 1 - \frac{1}{ɛ} )$$

Where q is the charge of the ion (e.g., aluminum), a is the radius of the ion (e.g., aluminum), and ε is the dielectric constant. The applied potential further plays a critical role to change the dielectric constant in the gel. Once the gel's dielectric constant is adjusted by applying potential, the solvation energy can be changed in the gel. Thus, thermodynamically the ion can be charged and discharged in the gel through alternative polarization of the electrode as schematically indicated in FIG. 4B.

### Additives

In some embodiments, the electrochemical cell may include one or more components or additives with the specific objectives that may include one or more of the following: (1) to promote the formation of an electrochemical active layer at the electrode-electrolyte interface and/or particle-electrolyte interface; (2) to promote the formation of a passivating layer at the electrode-electrolyte interface and/or particle-electrolyte interface; (3) to serve as a conductive additive to promote ion diffusion and/or electron diffusion; (4) to introduce stability, including one or more of structural stability (such as maintaining the original configuration of sheets, tunnels, or spinels), material stability (such as retention of original material and crystal properties), or to catalyze or improve or increase reversibility of electrochemical activity; and (4) to mitigate generation of gas or facilitate one or more of gas absorption, gas conversion, gas storage, or gas release. Such components may be introduced as an alloy or a mixture in one or more of anode, cathode, and separator. Such additives may include metals or alloys of one or more of lithium, lanthanum, palladium, indium, gallium, titanium, zinc, zirconium, bismuth, strontium, yttrium, barium, copper, zirconium, tungsten, silicon, ruthenium, thorium, iron, tin, nickel. The additives may also include oxides, carbides, hydrides, nitrides, nitrates, stannates, phosphates, sulfates, hydroxides, and oxide-hydroxides of one or more of lithium, lanthanum, palladium, indium, gallium, titanium, zinc, zirconium, bismuth, strontium, yttrium, barium, copper, zirconium, tungsten, silicon, ruthenium, thorium, iron, tin, and nickel. The additives may also include polymers including one or more of aniline, polyaniline, polypyrrole, and polythiophene. Finally, the additives may include ceramics including one or more of aluminum oxide, titanium oxide, vanadium oxide, silicon oxide, silicon carbide, tungsten carbide, boron oxide, boron nitride, silicon nitride, silicon aluminum oxynitride, zinc oxide, titanium carbide, zirconium oxide, ferrites.

In some embodiments the additive may also be introduced as an additive in the electrolyte. Such additives may include one or more of aniline, polyaniline, boric acid, and oxides, carbides, hydrides, nitrides, nitrates, stannates, phosphates, sulfates, hydroxides, triflates, sulfonimides, oxalatoborates, and oxide-hydroxides of one or more of lithium, sodium, potassium, lanthanum, palladium, indium, gallium, titanium, zinc, zirconium, bismuth, strontium, yttrium, barium, copper, zirconium, tungsten, silicon, ruthenium, thorium, iron, tin, and nickel.

In some embodiments, the component could be the separator material itself wherein the separator is comprised of one or more of aniline, polyaniline, polypyrrole, polythiophene, aluminum oxide, titanium oxide, vanadium oxide, silicon oxide, silicon carbide, tungsten carbide, boron oxide, boron nitride, silicon nitride, silicon aluminum oxynitride, zinc oxide, titanium carbide, zirconium oxide, and ferrites.

In some embodiments, the component could be coated as a film on an anode, a cathode, a separator, or a current collector substrate. Such coatings are comprised of oxides, carbides, hydrides, nitrides, nitrates, phosphates, sulfates, hydroxides, and oxide-hydroxides of one or more of lithium, lanthanum, palladium, indium, gallium, titanium, zinc, zirconium, bismuth, strontium, yttrium, barium, copper, zirconium, tungsten, silicon, ruthenium, thorium, iron, tin, and nickel.

In some embodiments, the additives serve as gas mitigation component.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. Having described certain implementations of electrochemical cells and components thereof, it will now become apparent to one of skill in the art that other implementations incorporating the concepts of the disclosure may be used. Therefore, the disclosure should not be limited to certain implementations, but rather the claimed invention should be limited only by the spirit and scope of the following claims.

1-115. (canceled)

116. An electrode for an electrochemical cell, the electrode comprising one or more electroactive vanadium oxide structures, the vanadium oxide having stoichiometry comprising VₓO_{y}, where x is from 1 to 2 and y is from 2 to 5 when in a form of a stable compound and x is from 1 to 4 and y is from 1 to 9 when in anionic and/or cationic forms.

117. The electrode of claim 116, wherein the vanadium oxide comprises one or more crystal structures and the one or more crystal structures are each independently selected from the group consisting of monoclinic, rutile, orthorhombic, and trigonal.

118. The electrode of claim 116, wherein the vanadium oxide has been formed to include one or more vacancies, one or more defects, one or more interstitial voids, or a combination thereof.

119. The electrode of claim 116, wherein at least one of the one or more vanadium oxide structures further comprises one or more monovalent or multivalent cations disposed in and/or on the one or more structures.

120. The electrode of claim 119, wherein the one or more monovalent or multivalent cations are selected from the group consisting of lithium, potassium, calcium, sodium, aluminum, gallium, indium, bismuth, zinc, copper, cerium, lanthanum, titanium, rubidium, iron, tin, lead, manganese, magnesium, cobalt, chromium, nickel, silver and combinations thereof.

121. The electrode of claim 119, wherein the one or more monovalent or multivalent cations are disposed (i) between layers of vanadium oxide in the at least one of the one or more vanadium oxide structures, (ii) at vacancies in the at least one of the one or more vanadium oxide structures, (iii) as one or more pillars extending from the at least one of the one or more vanadium oxide structures, (iv) at interstitial voids in the at least one of the one or more vanadium oxide structures, (v) at defect sites in the at least one of the one or more vanadium oxide structures, or (vi) any combination of (i)-(v).

122. The electrode of claim 116, wherein the one or more electroactive vanadium oxide structures are vanadium oxide particles.

123. The electrode of claim 116, wherein the one or more electroactive vanadium oxide structures have undergone carbonization.

124. The electrode of claim 116, wherein the one or more vanadium oxide structures are coated with carbon or have carbon interspersed within the one or more structures or both.

125. The electrode of claim 124, wherein the one or more vanadium oxide structures are coated with a film comprising carbon.

126. (canceled)

127. The electrode of claim 125, wherein the film has been formed by a process comprising physical vapor deposition, chemical vapor deposition, in situ or ex situ chemical reactions, spray drying, draw-down coating, doctor-blade coating, slot-die coating, comma-coating, or reverse comma-coating.

128. The electrode of claim 123, wherein the carbonization comprises incorporation of a conductive carbon additive into the vanadium oxide.

129. The electrode of claim 128, wherein the conductive carbon additive is selected from the group consisting of carbon black, carbon nanotubes, graphene sheets, acetylene black, carbon fiber, and combinations thereof.

130. (canceled)

131. The electrode of claim 123, wherein the one or more vanadium oxide structures are one or more vanadium oxide particles and the carbonization comprises incorporation of the carbon precursor before, during, or after particle synthesis and subsequent carbonization.

132. The electrode of claim 131, wherein the carbon precursor is selected from the group consisting of a monosaccharide, a disaccharide, an oligosaccharide, a polysaccharide, an organic acid, a polymer, a polyether, an aromatic carbon, and combinations thereof.

133. The electrode of claim 123, wherein the carbonization comprises a hydrothermal reaction, physical mixing, wet chemistry, electrochemical coating, spray pyrolysis, and spray drying to form a carbon in the one or more vanadium oxide species.

134. The electrode of claim 116, comprising one or more composites that comprise the one or more vanadium oxide structures.

135. The electrode of claim 134, wherein the one or more composites further comprise one or more additional compounds selected from the group consisting of metals, nitrates, nitrites, nitrides, sulfates, sulfites, sulfides, carbonates, carbides, phosphates, phosphites, acetates, oxides, hydroxides, oxalates, and halides of lithium, potassium, calcium, sodium, aluminum, gallium, indium, bismuth, zinc, copper, cerium, lanthanum, titanium, rubidium, iron, tin, lead, vanadium, magnesium, cobalt, chromium, nickel, and silver.

136. (canceled)

137. The electrode of claim 116, wherein the one or more electroactive vanadium oxide structures are one or more primary particles and the one or more composites are one or more secondary particles comprising the one or more primary particles.

138. (canceled)

139. The electrode of claim 116, wherein the one or more electroactive vanadium oxide structures are one or more primary particles and the electrode comprises one or more secondary particles comprising the one or more primary particles.

140. The electrode of claim 116, wherein the vanadium oxide is structured to accommodate reversible insertion of one or more of: lithium, sodium, potassium, cerium, calcium, aluminum, zinc, copper, titanium, rubidium, chromium, cobalt, iron, molybdenum, nickel, vanadium, silicon, manganese, magnesium, silicon, calcium, zirconium, ruthenium, indium, tin, and silver.

141. The electrode of claim 116, wherein the one or more electroactive vanadium oxide structures have undergone a structural modification, material property change, or both as a result of a pretreatment process, a formation process, or electrochemical cycling, wherein the one or more electroactive vanadium oxide structures became electroactive or more electroactive as a result of the structural modification, material property change, or both.

142. The electrode of claim 141, wherein the structural modification, material property change, or both comprises changing the stoichiometry of the vanadium oxide to comprise M_{z}VₓO_{y}, VₓO_{y}A_{z}, or M_{z}VₓO_{y}Aₙ, where M is a cation and A is an anion.

143. The electrode of claim 141, wherein the structural modification, material property change, or both comprises a change in crystal structure.

144. The electrode of claim 141, wherein the structural modification, material property change, or both increasing lattice spacing in the vanadium oxide between 0.1 nm and 1 nm.

145. The electrode of claim 116, wherein the electrode has been treated with a solution comprising ions selected from the group consisting of ions derived from nickel, copper, bismuth, indium, gallium, tin, zinc, tungsten, nitrates, sulfates, carbonates, carbides, acetates, halides, sulfonimides, triflates, tris(trimethylsilyl) borate, citric acid, oxalic acid, tartaric acid, salicylic acid, acetic acid, adipic acid, sebacic acid, boric acid, nitric acid, phosphoric acid, sulfuric acid, hydrochloric acid, and combinations thereof.

146. The electrode of claim 116, wherein the electrode has been treated with a solution comprising one or more components selected from the group consisting of lithium bis(trifluoromethanesulfonyl)imide, lithium bis(fluorosulfonyl)imide, potassium bis(trifluoromethanesulfonyl)imide, potassium bis(fluorosulfonyl)imide, sodium bis(trifluoromethanesulfonyl)imide, sodium bis(fluorosulfonyl)imide, aluminum bis(trifluoromethanesulfonyl)imide, aluminum bis(fluorosulfonyl)imide, manganese bis(trifluoromethanesulfonyl)imide, manganese bis(fluorosulfonyl)imide, lithium difluoro(oxalato)borate, lithium tetrafluoroborate, calcium tetrafluoroborate, potassium tetrafluoroborate, sodium tetrafluoroborate, lithium bis(trifluoromethanesulfonate), potassium bis(trifluoromethanesulfonate), calcium bis(trifluoromethanesulfonate), sodium bis(trifluoromethanesulfonate), aluminum bis(trifluoromethanesulfonate), manganese bis(trifluoromethanesulfonate), 1,1,2,2-tetrafluoroethyl-2′,2′,2′-trifluoroethyl ether, boric acid, ammonium tetrafluoroborate, sodium tetrafluoroborate, calcium tetrafluoroborate, potassium tetrafluoroborate, lithium tetrafluoroborate, pyrrole, aniline, vanillin, and thiophene.

147. The electrode of claim 145, wherein the electrode is comprised in an electrochemical cell and the treating has occurred prior to incorporation of the electrode into the electrochemical cell.

148. The electrode of claim 116, wherein the anode comprises a hydrophobic surface.

149. The electrode of claim 116, wherein the anode comprises a hydrophilic surface.

150-318. (canceled)
